(19) United States
(12) Patent Application Publication
(10) Pub. No.: US 2018/0046828 A1
(43) Pub. Date: Feb. 15, 2018

(54) INFORMATION PROCESSING APPARATUS, INFORMATION PROCESSING SYSTEM AND INFORMATION PROCESSING METHOD

(71) Applicant: FUJITSU LIMITED, Kawasaki-shi (JP)

(72) Inventors: Akito YAMAZAKI, Kawasaki (JP); Kazunori Kobashi, Yamato (JP); Yuri Shimada, Yokohama (JP); Hiroyuki Katayama, Numazu (JP)

(73) Assignee: FUJITSU LIMITED, Kawasaki-shi (JP)

(21) Appl. No.: 15/663,921

(22) Filed: Jul. 31, 2017

(30) Foreign Application Priority Data
Aug. 15, 2016 (JP) 2016-159387
Nov. 17, 2016 (JP) 2016-224042

(51) Int. Cl. G06F 21/62

(52) U.S. Cl. CPC G06F 21/6254; G06F 19/322

(57) ABSTRACT

A memory stores a plurality of pieces of information transferred respectively from a plurality of information provision institutions. A processor extracts a plurality of pieces of analysis target information that are to be provided to an analysis device, respectively from the plurality of pieces of information stored in the memory. A communication interface circuit transfers the plurality of pieces of information to a first storage device via a first communication network and transfers the plurality of pieces of analysis target information to a second storage device connected to a second communication network. The second communication network is separated from the first communication network and the analysis device is connected to the second communication network.

### CROSS-REFERENCE TO RELATED APPLICATIONS

This application is based upon and claims the benefit of priority of the prior Japanese Patent Application No. 2016-159387, filed on Aug. 15, 2016, and the Japanese Patent Application No. 2016-224042, filed on Nov. 17, 2016, the entire contents of which are incorporated herein by reference.

### FIELD

The embodiments discussed herein are related to an information processing apparatus, an information processing system and an information processing method.

### BACKGROUND

In recent years, there is an increasing demand for big data analysis. In order to obtain more accurate and more useful analysis results in big data analysis, it is desirable to collect as many data samples as possible.

The government of Japan has a plan to carry out policy to promote big data analysis in the domestic medical field in the future. This plan aims at a situation where pieces of data of electronic medical records are collected from hospitals, the collected pieces of data are processed to anonymous data, and groups that wish to use the anonymous data are provided with the data as data available for big data analysis.

An electronic medical record is data including much personal information that is related to privacy of patients. Thus, it is desirable that measures be taken to prevent leaks of personal information when a great amount of this kind of data is collected.

Techniques that collect and use gene information are also known (see Patent Documents 1 and 2 for example).

Patent Document 1: Japanese Laid-open Patent Publication No. 11-353404

Patent Document 2: Japanese Laid-open Patent Publication No. 2004-287847

### SUMMARY

According to an aspect of the embodiments, an information processing apparatus includes a memory, a processor coupled to the memory and a communication interface circuit. The memory stores a plurality of pieces of information transferred respectively from a plurality of information provision institutions. The processor extracts a plurality of pieces of analysis target information that are to be provided to an analysis device, respectively from the plurality of pieces of information stored in the memory. The communication interface circuit transfers the plurality of pieces of information to a first storage device via a first communication network and transfers the plurality of pieces of analysis target information to a second storage device connected to a second communication network. The second communication network is separated from the first communication network and the analysis device is connected to the second communication network.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram of an electronic-medical-record analysis system;

FIG. 2 illustrates a data provision sequence;

FIG. 3 illustrates a data analysis sequence;

FIG. 4 is a configuration diagram of a first information processing system;

FIG. 5 is a flowchart of an information extraction process;

FIG. 6 illustrates a specific example of an information processing system of medical record information;

FIG. 7 illustrates a functional configuration diagram of a virtual machine;

FIG. 8 illustrates logical volumes of medical record information and analysis target information;

FIG. 9 illustrates an example of an input screen of consultation information;

FIG. 10 illustrates medical record information of hospital A;

FIG. 11 illustrates medical record information of hospital B;

FIG. 12 illustrates analysis target item information;

FIG. 13 illustrates analysis target information of hospital A;

FIG. 14 illustrates analysis target information of hospital B;

FIG. 15 illustrates integrated analysis target information of a hospital;

FIG. 16 illustrates an analysis process of medical record information;

FIG. 17A illustrates an information extraction sequence of hospital A (first part);

FIG. 17B illustrates the information extraction sequence of hospital A (second part);

FIG. 18A illustrates an information extraction sequence of hospital B (first part);

FIG. 18B illustrates the information extraction sequence of hospital B (second part);

FIG. 19 illustrates a first information analysis sequence;

FIG. 20 illustrates a server system and a storage system;

FIG. 21 illustrates a first volume-allocation sequence;

FIG. 22 illustrates a specific example of an information processing system of purchase information;

FIG. 23 illustrates an input screen of purchase information;

FIG. 24 illustrates purchase information of convenience store A;

FIG. 25 illustrates analysis target information of convenience store A;

FIG. 26 illustrates analysis target information of convenience store B;

FIG. 27 illustrates integrated analysis target information of convenience stores;

FIG. 28 illustrates analysis process of purchase information;

FIG. 29 is a configuration diagram of a second information processing system;

FIG. 30 is a flowchart of an information obtainment process;

FIG. 31 is a configuration diagram of an analysis system;

FIG. 32 illustrates a first table;

FIG. 33 illustrates a second table;

FIG. 34 illustrates a second volume-allocation sequence;

FIG. 35 illustrates a second information analysis sequence; and

FIG. 36 illustrates a hardware configuration of an information processing apparatus.

### DESCRIPTION OF EMBODIMENTS

Hereinafter, detailed explanations will be given for the embodiments by referring to the drawings.

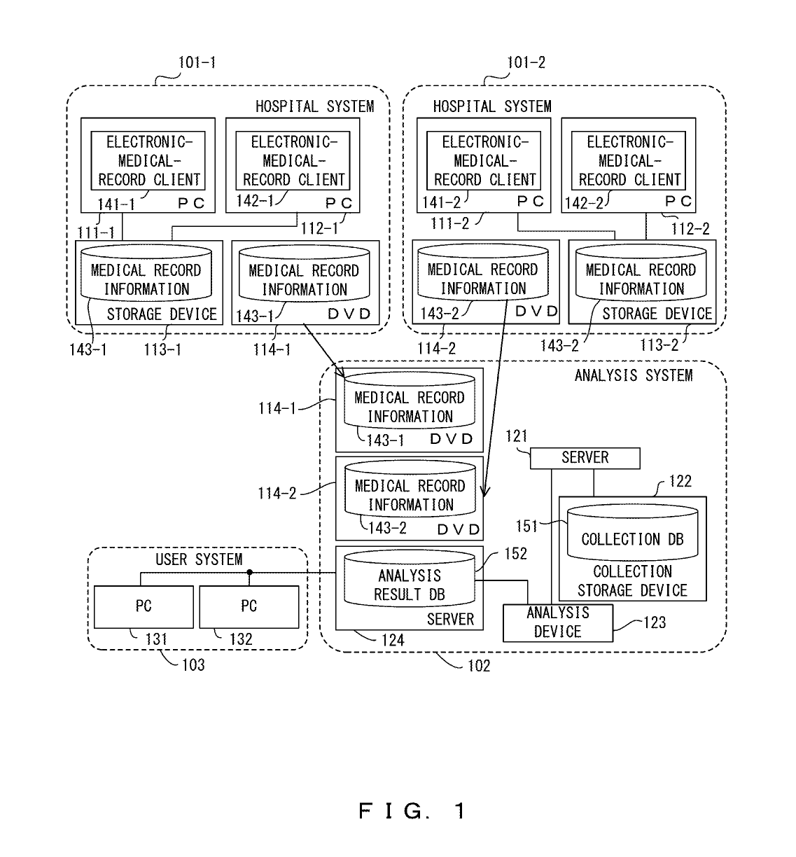

FIG. 1 illustrates a configuration example of a hypothetical electronic-medical-record analysis system that collects and analyzes electronic medical records in accordance with the policy of the government of Japan. In the electronic-medical-record analysis system illustrated in FIG. 1, an information provision institution is a hospital that provides data of electronic medical records, an information analysis institution is an institution such as the government etc. that collects and analyzes data of electronic medical records, and an information using institution is an institution such as a research institution, a pharmaceutical company, etc. that uses analysis results.

The electronic-medical-record analysis system illustrated in FIG. 1 includes a hospital system 101-1 of hospital A, a hospital system 101-2 of hospital B, an analysis system 102 of an information analysis institution and a user system 103 of an information using institution. The number of the hospital systems is not limited to two, and three or more hospital systems may exist when there are three or more hospitals. For example, a plurality of hospitals existing across the country may serve as information provision institutions.

The hospital system 101-i (i=1, 2) includes a personal computer (PC) 111-i, a PC 112-i and a storage device 113-i. The PCs 111-i and 112-i and the storage device 113-i are connected via for example a local area network (LAN). The PCs 111-1 and 112-1 have electronic-medical-record clients 141-i and 142-i installed as applications in them, respectively.

The analysis system 102 includes a sever 121, a collection storage device 122, an analysis device 123 and a server 124. The collection storage device 122 includes a collection database (DB) 151, and the server 124 includes an analysis result DB 152. The analysis device 123 is for example a PC of an analyzer. The user system 103 includes a PC 131 and a PC 132.

In the electronic-medical-record analysis system illustrated in FIG. 1, an electronic medical record is analyzed in for example the following order.

(P1) A doctor of each hospital uses the electronic-medical-record client 141-i or the electronic-medical-record client 142-i so as to input consultation information of a patient.

(P2) The storage device 113-i stores input consultation information, as medical record information 143-i.

(P3) The doctor stores, in a Digital Versatile Disk (DVD) 114-i, a copy of the medical record information 143-i stored in the storage device 113-i.

(P4) Each hospital delivers the DVD 114-i to an information analysis institution.

(P5) An analyzer in the information analysis institution uses the analysis device 123 so as to read the medical record information 143-i from the delivered DVD 114-i, and stores the copy of the medical record 143-i in the collection DB 151.

(P6) The analyzer uses the analysis device 123 so as to obtain the medical record information 143-i of a plurality of patients from the collection DB 151, and analyzes the obtained medical record information 143-i.

(P7) The analyzer uses the analysis device 123 so as to confidentialize personal information included in analysis results, and stores the confidentialized analysis results in the analysis result DB 152. Thereby, the analysis results are processed into anonymous data.

(P8) The information analysis institution provides the analysis results to the user system 103 of the information using institution, and a user of the information using institution uses the PC 131 or 132 so as to obtain the analysis results from the analysis result DB 152.

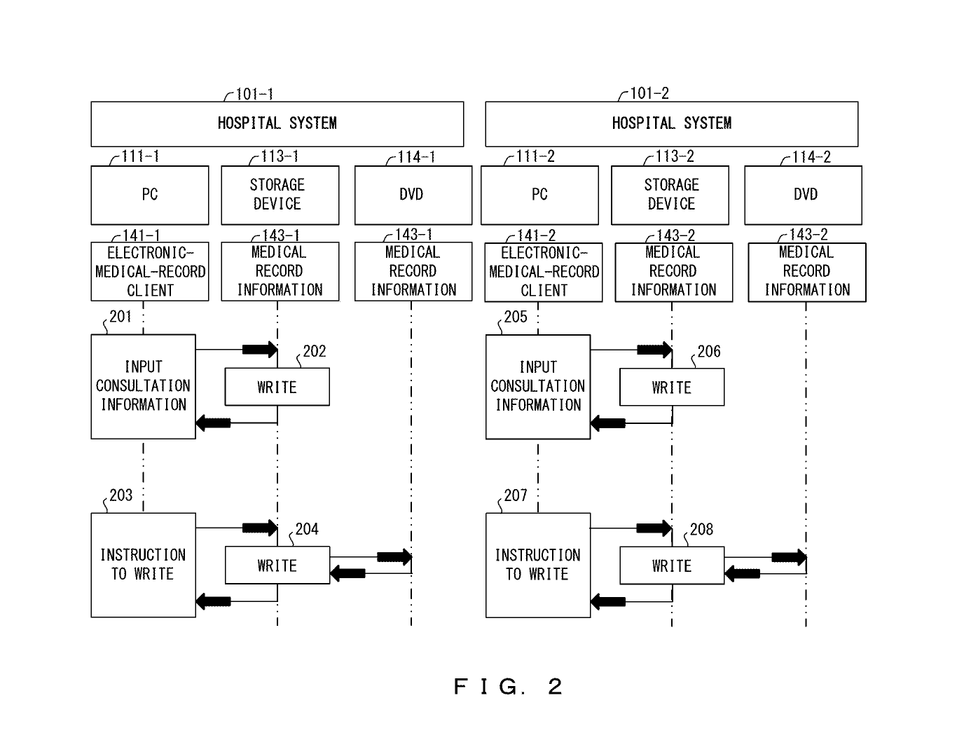

FIG. 2 illustrates an example of a data provision sequence in the hospital system 101-1 and the hospital system 101-2. In the hospital system 101-1, the electronic-medical-record client 141-i in the PC 111-1 inputs consultation information of a patient in accordance with manipulation conducted by a doctor of hospital A (step 201), and writes the medical record information 143-1 to the storage device 113-1 (step 202).

Next, in accordance with manipulation by the doctor, the electronic-medical-record client 141-1 instructs the storage device 113-1 to write the medical record information 143-1 (step 203). Then, the storage device 113-1 writes a copy of the medical record information 143-1 to the DVD 114-1 (step 204).

In the hospital system 101-2, the electronic-medical-record client 141-2 in the PC 111-2 inputs consultation information of a patient in accordance with manipulation conducted by a doctor of hospital B (step 205), and writes the medical record information 143-2 to the storage device 113-2 (step 206).

Next, in accordance with manipulation by the doctor, the electronic-medical-record client 141-2 instructs the storage device 113-2 to write the medical record information 143-2 (step 207). Then, the storage device 113-2 writes a copy of the medical record information 143-2 to the DVD 114-2 (step 208).

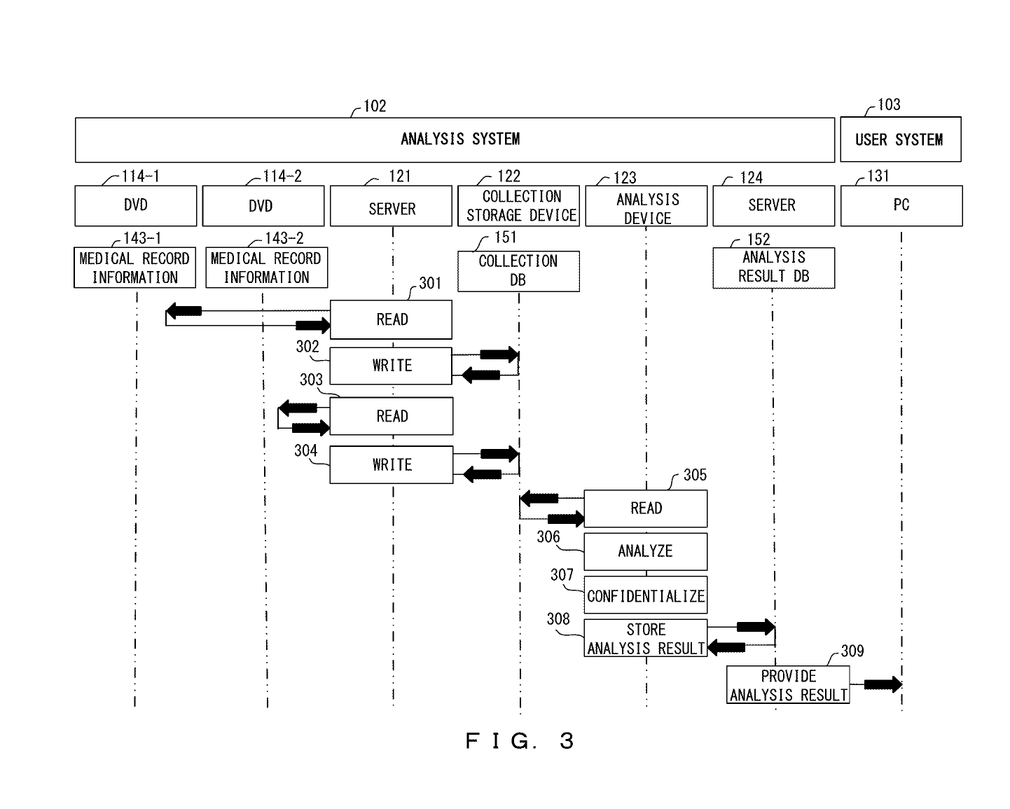

FIG. 3 illustrates an example of a data analysis sequence in the analysis system 102 illustrated in FIG. 1. First, in accordance with an instruction from an analyzer of an information analysis institution, the server 121 reads the medical record information 143-1 from the DVD 114-1 (step 301), and writes the medical record information 143-1 to the collection DB 151 of the collection storage device 122 (step 302).

Next, the server 121 reads the medical record information 143-2 from the DVD 114-2 in accordance with an instruction from the analyzer (step 303), and writes the medical record information 143-2 to the collection DB 151 (step 304).

Next, in accordance with manipulation from the analyzer, the analysis device 123 reads the medical record information 143-1 and the medical record information 143-2 from the collection DB 151 (step 305). Next, in accordance with manipulation by the analyzer, the analysis device 123 analyzes the medical record information 143-1 and the medical record information 143-2 (step 306), and confidentializes personal information included in the analysis results (step 307). Then, the analysis device 123 stores the confidentialized analysis results in the analysis result DB 152 of the server 124 (step 308).

Next, the server 124 provides the PC 131 of the user system 103 with the analysis results stored in the analysis result DB 152 (step 309).

In the electronic-medical-record analysis system illustrated in FIG. 1, the medical record information 143-i is collected by physically carrying the DVD 114-i from each hospital to an information analysis institution, and accordingly it takes time and effort to collect information, making real-time collection of information difficult.

Also, because analyzers of an information analysis institution that manages the collection DB 151 are allowed to refer to the medical record information 143-i that has not been confidentialized, there is a possibility that consultation information of a patient will leak from the analyzers.

Note that this problem arises not only in a case when electronic medical records of hospitals are collected, but also in a case when other types of information are collected in other types of information provision institutions.

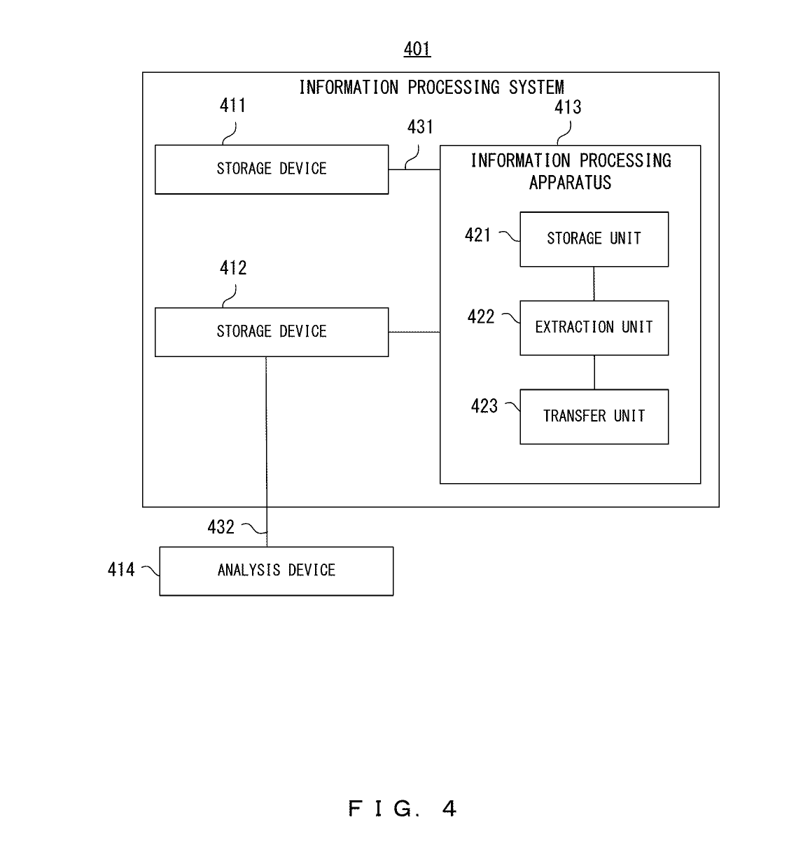

FIG. 4 illustrates a configuration example of a first information processing system of an embodiment. An information processing system 401 illustrated in FIG. 4 includes a storage device 411, a storage device 412 and an information processing apparatus 413 (computer), and the information processing apparatus 413 includes a storage unit 421, an extraction unit 422 and a transfer unit 423.

The storage device 411 is connected to a communication network 431, and stores a plurality of pieces of information transferred respectively from a plurality of information provision institutions. The storage device 412 is connected to a communication network 432, and stores a plurality of pieces of analysis target information provided to the analysis device 414. The communication network 432 is separated from the communication network 431, and the analysis device 414 is connected to the communication network 432.

The information processing apparatus 413 receives the plurality of pieces of information respectively from the plurality of information provision institutions, and the transfer unit 423 transfers the plurality of pieces of received information to the storage device 411 via the communication network 431. Then, the information processing apparatus 413 obtains the plurality of pieces of information from the storage device 411 so as to store them in the storage unit 421. The extraction unit 422 and the transfer unit 423 perform an information extraction process for the plurality of pieces of information stored in the storage unit 421.

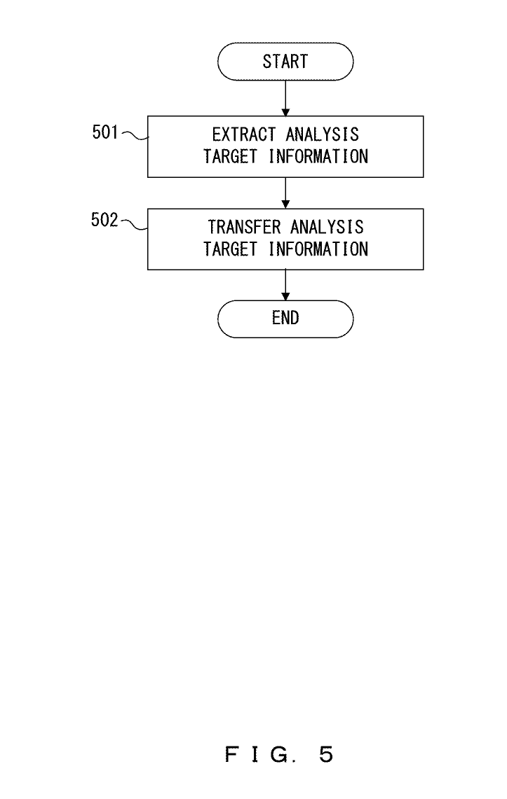

FIG. 5 is a flowchart illustrating an example of a first information extraction process that is performed by the information processing apparatus 413 illustrated in FIG. 4. First, the extraction unit 422 extracts the plurality of pieces of analysis target information respectively from the plurality of pieces of information stored in the storage unit 421 (step 501). Then, the transfer unit 423 transfers the plurality of pieces of analysis target information to the storage device 412 (step 502).

The information processing system 401 as described above makes it possible to reduce the risk of information leak in a case when pieces of information collected from a plurality of information provision institutions are analyzed.

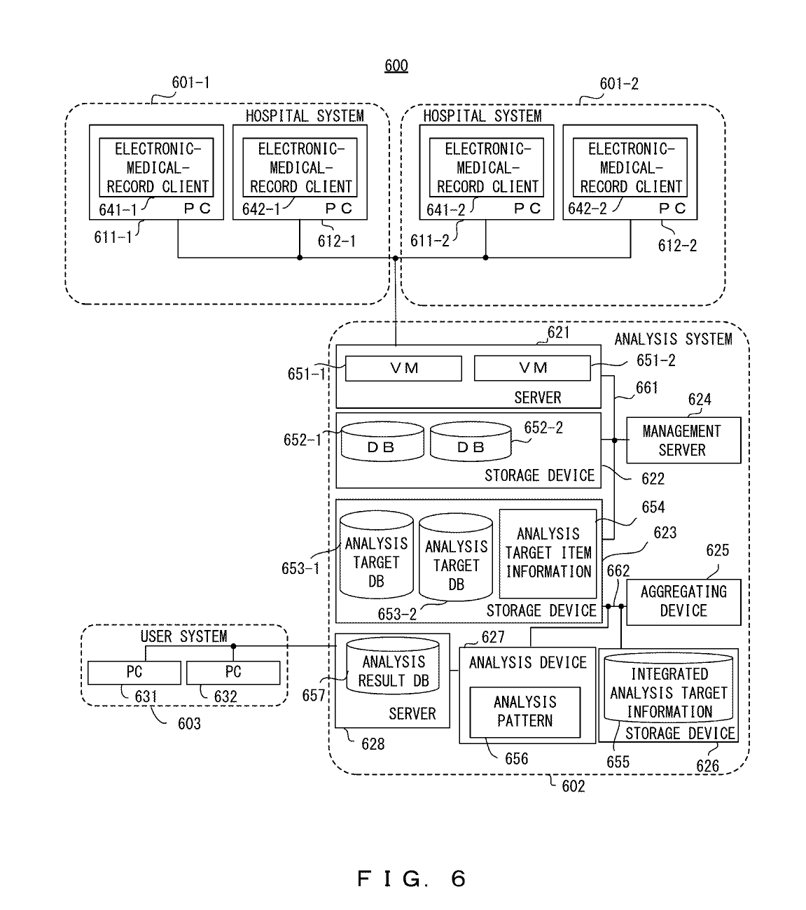

FIG. 6 illustrates a specific example of the information processing system 401 illustrated in FIG. 4. An information processing system 600 illustrated in FIG. 6 includes a hospital system 601-1 of hospital A, a hospital system 601-2 of hospital B, an analysis system 602 of an information analysis institution and a user system 603 of an information using institution. Similarly to the electronic-medical-record analysis system illustrated in FIG. 1, the number of the hospital systems may be three or more.

The hospital system 601-i (i=1, 2) includes a PC 611-i and a PC 612-i. The PCs 611-i and 612-i have electronic-medical-record clients 641-i and 642-i installed as applications in them, respectively.

The analysis system 102 includes a sever 621, a storage device 622, a storage device 623, a management server 624, an aggregating device 625, a storage device 626, an analysis device 627 and a server 628. The sever 621, the storage device 622, the storage device 623 and the management server 624 are connected to the communication network 661. Also, the storage device 623, the aggregating device 625, the storage device 626 and the analysis device 627 are connected to the communication network 662.

The sever 621 and the storage device 622 are a cloud system provided on a communication network such as the Internet, and are operated by a virtual machine (VM) 651-1 of hospital A and a VM 651-2 of hospital B in the sever 621. The storage device 622 includes a DB 652-1 of hospital A and a DB 652-2 of hospital B.

The storage device 623 includes an analysis target DB 653-1 of hospital A and a analysis target DB 653-2 of hospital B, and stores analysis target item information 654. The analysis target item information 654 is information that specifies an item as an analysis target from among a plurality of items included in medical record information of each patient of each hospital. The analysis target item information 654 may be set by an information analysis institution or may be set by an information provision institution. For an item as an analysis target, for example an item other than personal information of a patient by which the person is not identified is specified.

The storage device 622 and the storage device 623 respectively correspond to the storage device 411 and the storage device 412 of FIG. 4, and the sever 621 corresponds to the information processing apparatus 413. The communication network 661 and the communication network 662 respectively correspond to the communication network 431 and the communication network 432, and are separated by the storage device 623.

The management server 624 allocates the physical volumes of the DB 652-i and the analysis target DB 653-i to each VM 651-i. The aggregating device 625 generates integrated analysis target information 655, and the storage device 626 stores the integrated analysis target information 655. The analysis device 627 is for example a PC of an analyzer, and stores an analysis pattern 656. The analysis pattern 656 is information that specifies a pattern of an analysis process on the integrated analysis target information 655. The server 628 includes an analysis result DB 657. The user system 603 includes a PC 631 and a PC 632.

In the information processing system 600 illustrated in FIG. 6, an electronic medical record is analyzed in for example the following order.

(P11) A doctor of each hospital uses the electronic-medical-record client 641-i or the electronic-medical-record client 642-i so as to input consultation information of a patient. Consultation information is input in a common format that is common among all hospitals.

(P12) The electronic-medical-record client 641-i or the electronic-medical-record client 642-i transmits input consultation information to the sever 621 of the analysis system 602 as medical record information.

(P13) VM 651-i in the sever 621 transfers received medical record information to the storage device 622 via the communication network 661.

(P14) The storage device 622 stores received medical record information in the DB 652-i.

(P15) The VM 651-i refers to the analysis target item information 654 so as to extract information of an item as an analysis target from medical record information, and transfers the extracted information to the storage device 623 via the communication network 661.

(P16) The storage device 623 stores received information in the analysis target DB 653-i as analysis target information.

(P17) The aggregating device 625 obtains a plurality of pieces of analysis target information from the analysis target DB 653-1 and the analysis target DB 653-2 of the storage device 623 via the communication network 662, and merges the obtained pieces of analysis target information so as to generate the integrated analysis target information 655. Then, the aggregating device 625 transfers the integrated analysis target information 655 to the storage device 626 via the communication network 662. For example, the aggregating device 625 may generate the integrated analysis target information 655 when an information using institution has made a request to an information analysis institution for an analysis result.

(P18) The storage device 626 stores received integrated analysis target information 655.

(P19) An analyzer of an information analysis institution uses the analysis device 627 so as to make a request to the storage device 626 for the integrated analysis target information 655 corresponding to the analysis pattern 656. Then, the storage device 626 transmits the integrated analysis target information 655 to the analysis device 627 via the communication network 662.

(P20) The analyzer uses the analysis device 627 so as to analyze the integrated analysis target information 655 and transmit the analysis result to the server 628.

(P21) The server 628 stores received analysis result in the analysis result DB 657.

(P27) The information analysis institution provides the analysis result to the user system 603 of an information using institution, and an user of the information using institution uses the PC 631 or 632 so as to obtain the analysis result.

The information processing system 600 as described above eliminates the need to provide a database in the hospital system 601-i because each hospital utilizes the DB 652-i in the cloud system. In such a case, doctors of each hospital do not need to deliver medical record information to information analysis institutions and can transmit medical record information to the DB 652-i by using the PC 611-i or the PC 612-i, saving the efforts of collecting information and making real-time collection possible.

Also, by using the storage device 623 to separate the communication network 661 and the communication network 662, accesses from the aggregating device 625 or the analysis device 627 to the storage device 622 that stores medical record information are prohibited. Meanwhile, in the storage device 623 that can be accessed from the aggregating device 625 and the analysis device 627, analysis target information in which personal information of a patient included in medical record information has been confidentialized is stored. This reduces the risk that personal information of a patient will leak though analyzers.

Also, by inputting consultation information of respective hospitals in a common format and extracting analysis target information from medical record information in a common format, a plurality of hospitals have unified items as analysis target information, making easy to merge such pieces of analysis target information. Further, by the analysis device 627 storing the analysis pattern 656, it is possible to automatically make a request for the integrated analysis target information 655 of the same pattern when an analysis process is to be performed.

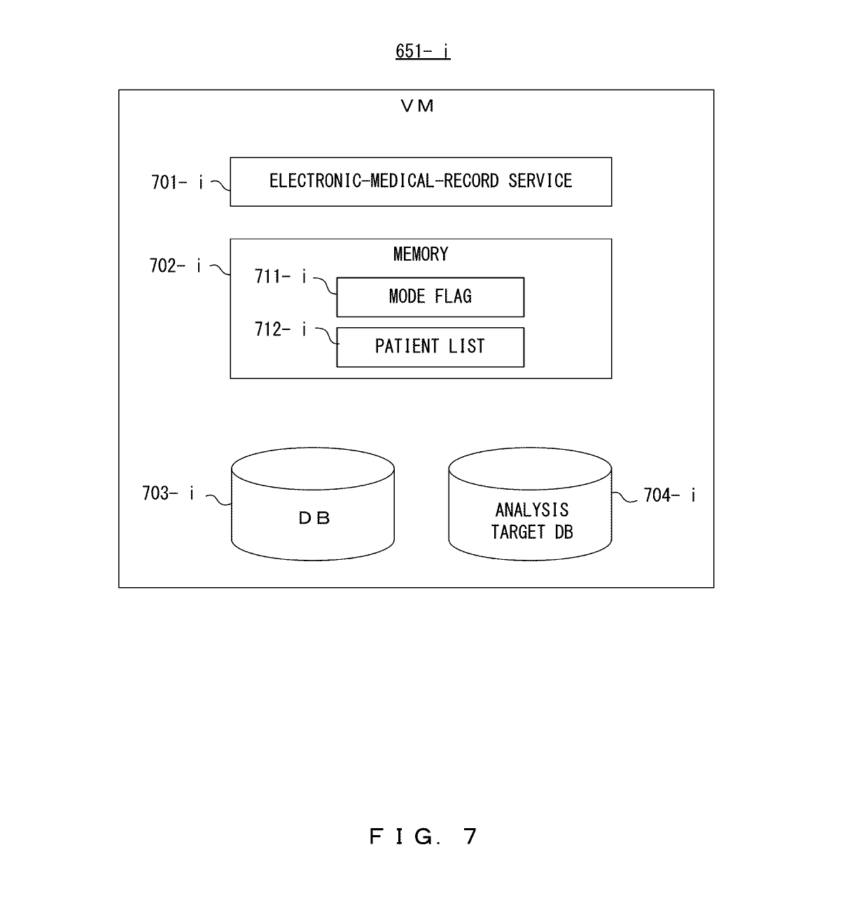

FIG. 7 illustrates a functional configuration example of the VM 651-i of FIG. 6. The VM 651-i illustrated in FIG. 7 includes an electronic-medical-record service 701-i, a memory 702-i, a DB 703-i and an analysis target DB 704-i. The electronic-medical-record service 701-i is an application executed by the VM 651-i, and provides the function of the extraction unit 422 illustrated in FIG. 4. The memory 702-i corresponds to a storage area in the storage unit 421 illustrated in FIG. 4, and stores a mode flag 711-i and a patient list 712-i.

The mode flag 711-i indicates whether or not to provide medical record information of each hospital to an information analysis institution, and indicates that medical record information is to be provided when it is logic “1”, and indicates that medical record information is not to be provided when it is logic “0”. When it is not desirable for a hospital to provide medical record information, the extraction of analysis target information can be prohibited by setting the mode flag 711-i of the corresponding VM 651-i to logic “0”. Accordingly, even a hospital that does not provide medical record information can use the DB 652-i of the information processing system 600.

The patient list 712-i includes a correspondence relationship between the name of a patient who had consultation in each hospital in the past and the identification information (ID) assigned to that patient. Provision of the patient list 712-i makes it possible to determine whether or not new medical record information that has been added to the DB 652-i is medical record information of a patient who had consultation.

The DB 703-i is a logical volume corresponding to the physical volume of the DB 652-i, and the analysis target DB 704-i is a logical volume corresponding to the physical volume of the analysis target DB 653-i. Provision of the VM 651-i for each hospital reduces the risk of information leak between hospitals.

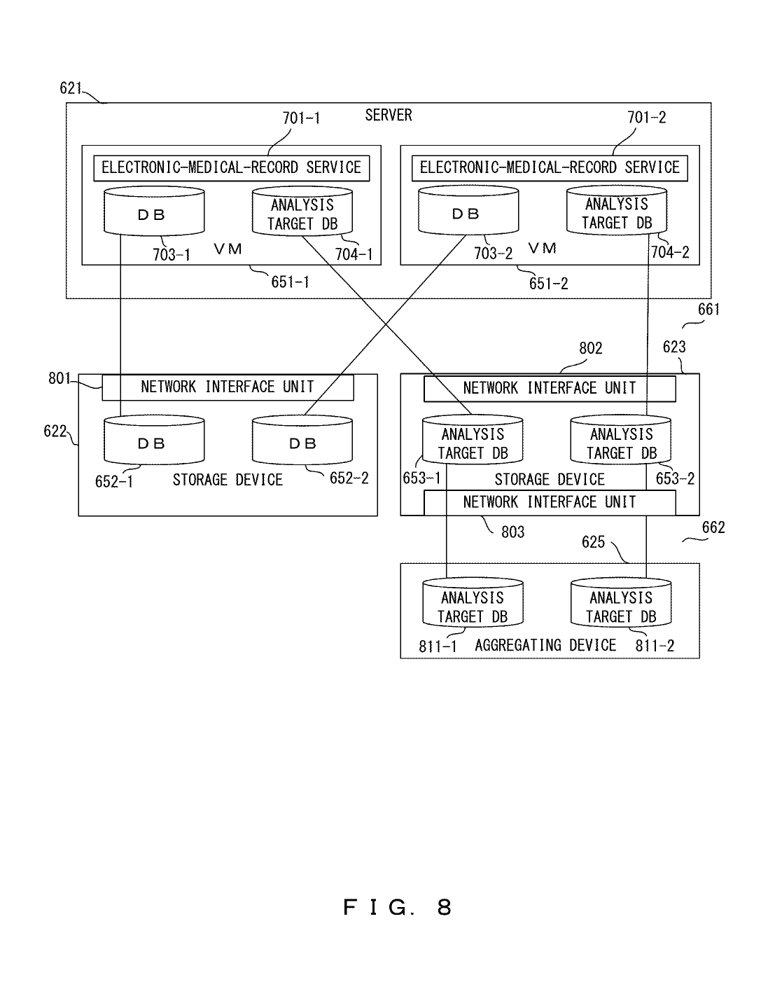

FIG. 8 illustrates an example of logical volumes of medical record information and analysis target information in the information processing system 600. The storage device 622 includes a network interface unit 801 connected to the communication network 661. Also, the storage device 623 includes a network interface unit 802 connected to the communication network 661 and a network interface unit 803 connected to the communication network 662.

The network interface unit 801, the network interface unit 802 and the network interface unit 803 are communication circuits (network interface circuits) such as a network interface card (NIC) etc.

The VM 651-i of the sever 621 accesses the storage device 622 via the communication network 661 so as to hold the logical volume corresponding to the physical volume of the DB 652-i as the DB 703-i. The network interface unit 801 of the storage device 622 can transmit medical record information of the physical volume to the sever 621 in accordance with a request from the VM 651-i.

Also, the VM 651-i accesses the storage device 623 via the communication network 661 so as to hold the logical volume corresponding to the physical volume of the analysis target DB 653-i as the DB 704-i. The network interface unit 802 of the storage device 623 can transmit analysis target information of the physical volume to the sever 621 in accordance with a request from the VM 651-i.

The aggregating device 625 accesses the storage device 623 via the communication network 662 so as to hold the logical volume corresponding to the physical volume of the analysis target DB 653-i as the analysis target DB 811-i. The network interface unit 803 of the storage device 623 can transmit analysis target information of the physical volume to the aggregating device 625 in accordance with a request from the aggregating device 625.

Connecting the network interface unit 802 and the network interface unit 803 of the storage device 623 respectively to the communication network 661 and the communication network 662 makes it possible to physically separate these communication networks. Also, because the storage device 623 usually includes an operating system (OS) dedicated for storages, the risk that analysis target information will leak from the storage device 623 is reduced very much in comparison with versatile OSs.

Thereby, it is possible to permit accesses to the DB 652-i of the storage device 622 connected to the communication network 661 only to the user of the hospital system 601-i and prohibit analyzers of information analysis institutions from making such accesses.

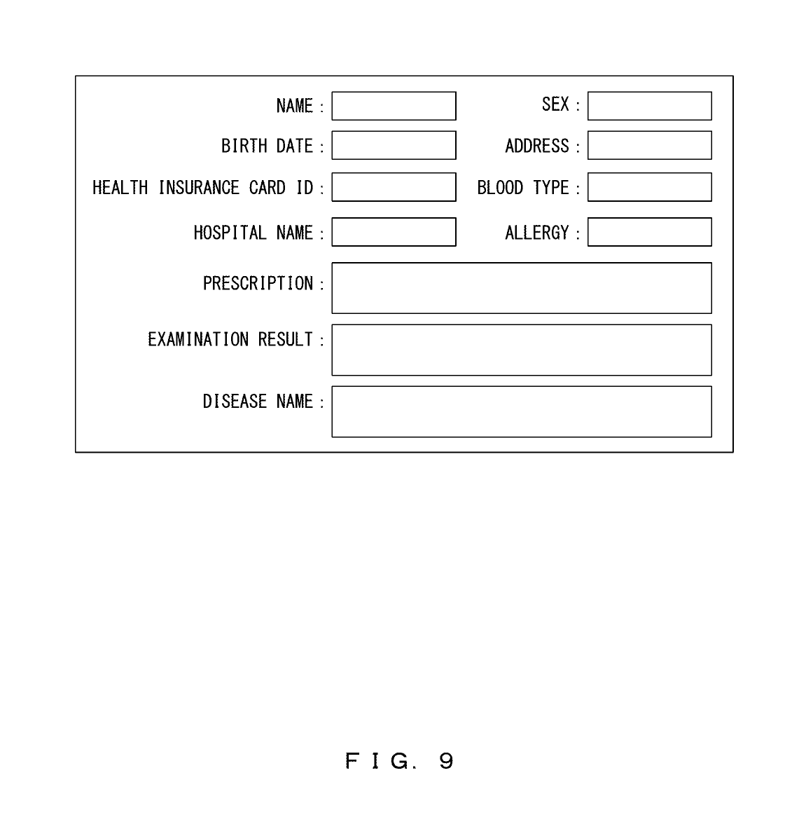

FIG. 9 illustrates an example of an input screen, displayed by the PC 611-i or the PC 612-i, of consultation information that uses a common format. The input screen illustrated in FIG. 9 includes items of name of patient, sex, birth date, address, blood type, health insurance card ID, hospital name, allergy, prescription, examination result and disease name.

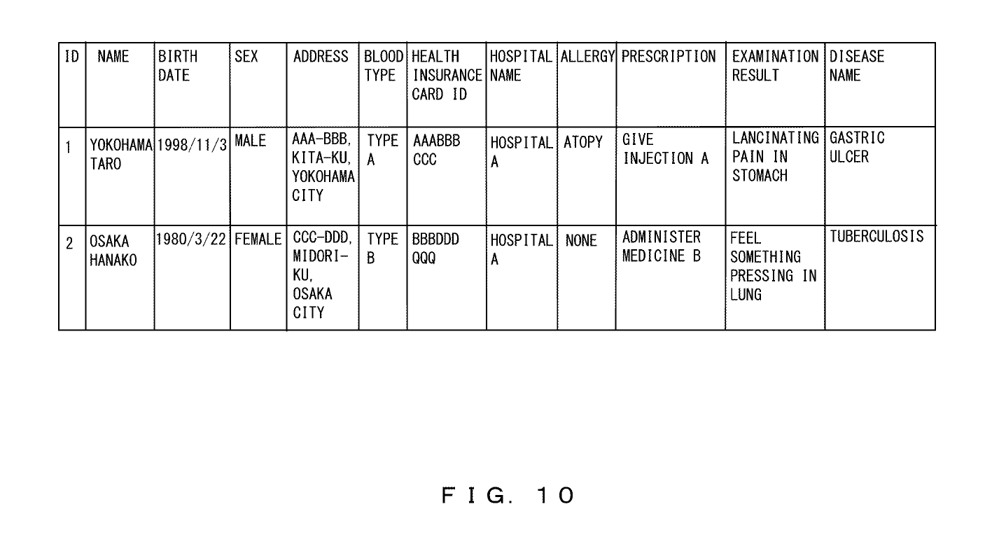

FIG. 10 illustrates an example of medical record information stored in the DB 652-1 of hospital A. The medical record information of FIG. 10 includes items of ID, name, birth date, sex, address, blood type, health insurance card ID, hospital name, allergy, prescription, examination result and disease name. An ID is an ID assigned to a patient by each hospital, and a health insurance card ID is an ID assigned to an insured person by an insurer.

Allergy represents an allergy that a patient has, prescription represents prescription determined through consultation, an examination result represents an examination result that was referred to during consultation, and a disease name represents the disease name determined through consultation. In the example illustrated in FIG. 10, pieces of medical record information of the two patients corresponding to IDs “1” and “2” have been registered in the DB 652-1.

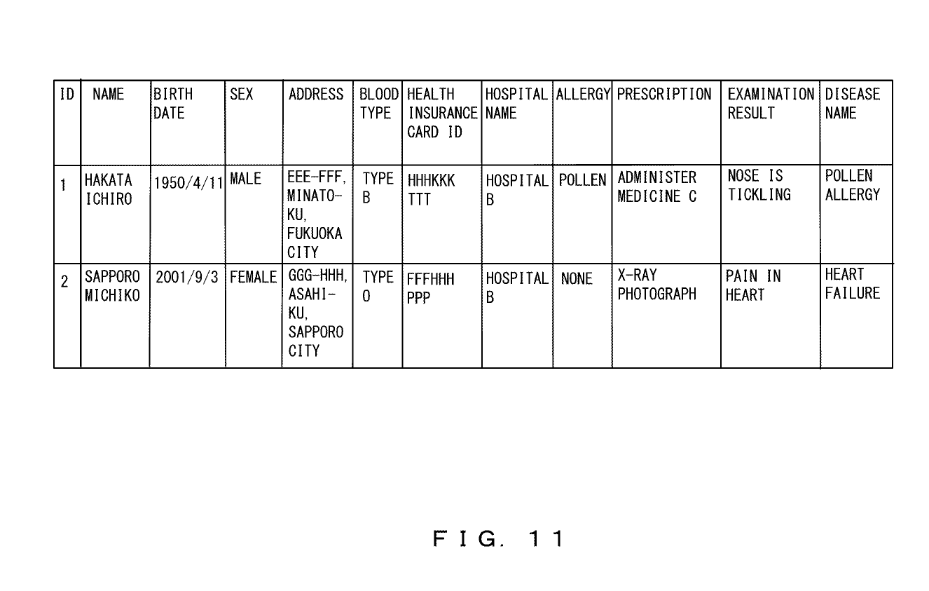

FIG. 11 illustrates an example of medical record information stored in the DB 652-2 of hospital B. The medical record information of FIG. 11 has similar items to those of the medical record information of FIG. 10. In the example illustrated in FIG. 11, pieces of medical record information of the two patients corresponding to IDs “1” and “2” have been registered in the DB 652-2.

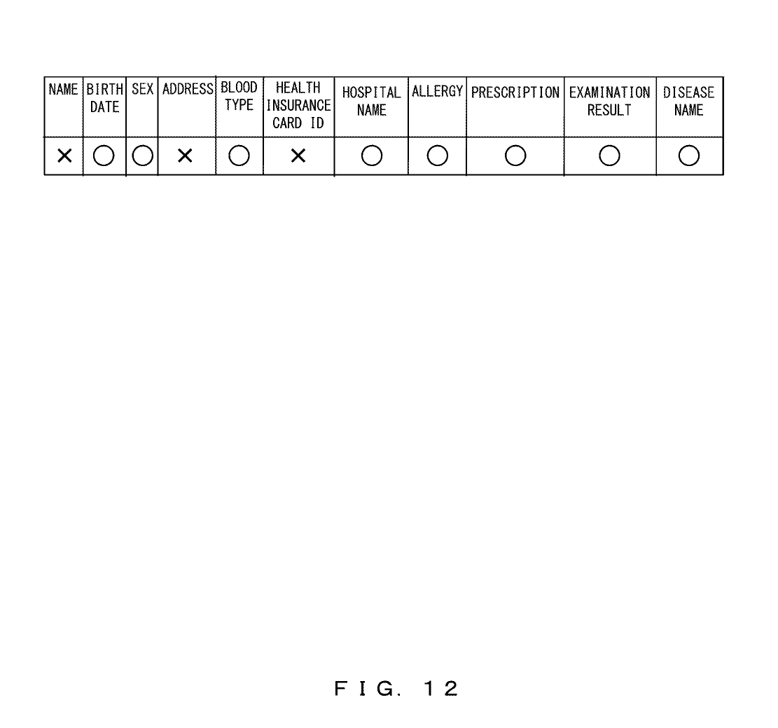

FIG. 12 illustrates an example of the analysis target item information 654. The items of the analysis target item information 654 illustrated in FIG. 12 correspond to the items of medical record information illustrated in FIG. 10 and FIG. 11, and include a symbol of either “o” or “x”.

“o” represents information that can be provided without being confidentialized, and corresponds to an item as an analysis target. “x” represents information that is to be confidentialized, and corresponds to an item as a non analysis target. In this example, “o” is set for the birth date, the sex, the blood type, the hospital name, the allergy, the prescription, the examination result and the disease name, and “x” is set for the name, the address, and the health insurance card ID.

Provision of the analysis target item information 654 as described above makes it possible to extract information of an item as an analysis target from medical record information of each hospital in accordance with a common criterion for judgment. Also, even when a criterion for judgment has been changed by an information analysis institution etc., the operation of the analysis system 602 can be continued just by changing the setting of the analysis target item information 654.

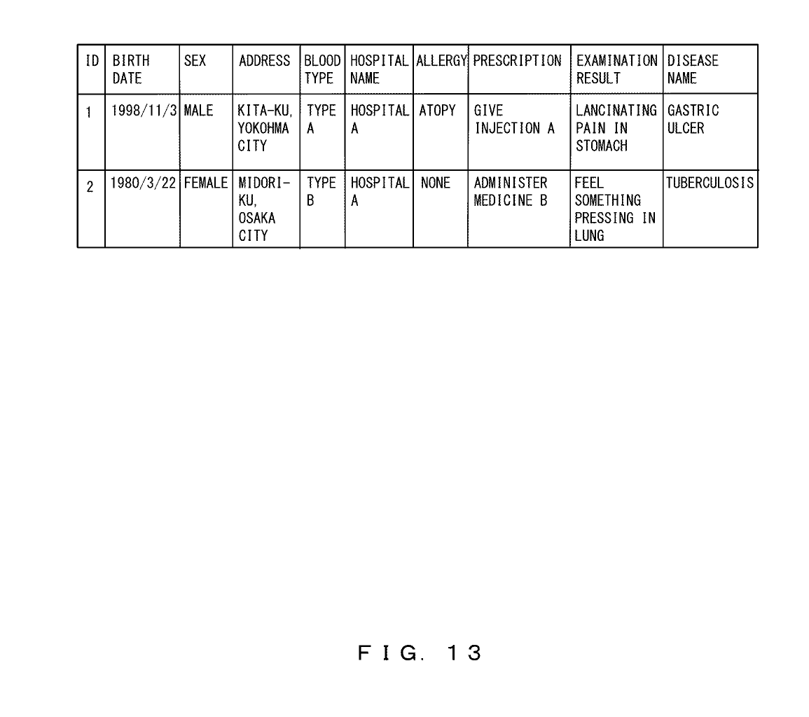

FIG. 13 illustrates an example of analysis target information generated from the medical record information illustrated in FIG. 10 on the basis of the analysis target item information 654 illustrated in FIG. 2. The analysis target information illustrated in FIG. 13 includes the items of ID, birth date, sex, address, blood type, hospital name, allergy, prescription, examination result, and disease name. In such a case, because the name and the health insurance card ID are specified by the analysis target item information 654 as information to be confidentialized, the name or the health insurance card ID are not extracted as analysis target information.

While the address is also specified as information to be confidentialized, a confidentialization process of omitting the block number etc. included in the character string of the address is applied so that it has been processed to information that does not allow the identification of the person. For example, the address of the patient having ID “1” has been converted into a simplified character string of “Kita-ku, Yokohama city”, and the address of the patient having ID “2” has been converted into a simplified character string of “Midori-ku, Osaka city”.

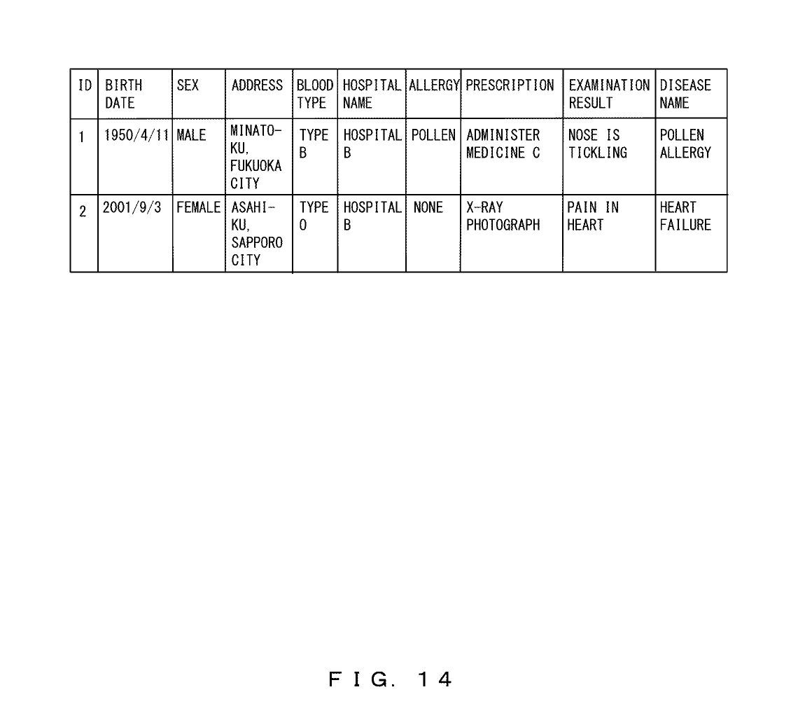

FIG. 14 illustrates an example of analysis target information generated from the medical record information illustrated in FIG. 11 on the basis of the analysis target item information 654 illustrated in FIG. 12. The analysis target information of FIG. 14 also has similar items as those of the analysis target information of FIG. 13.

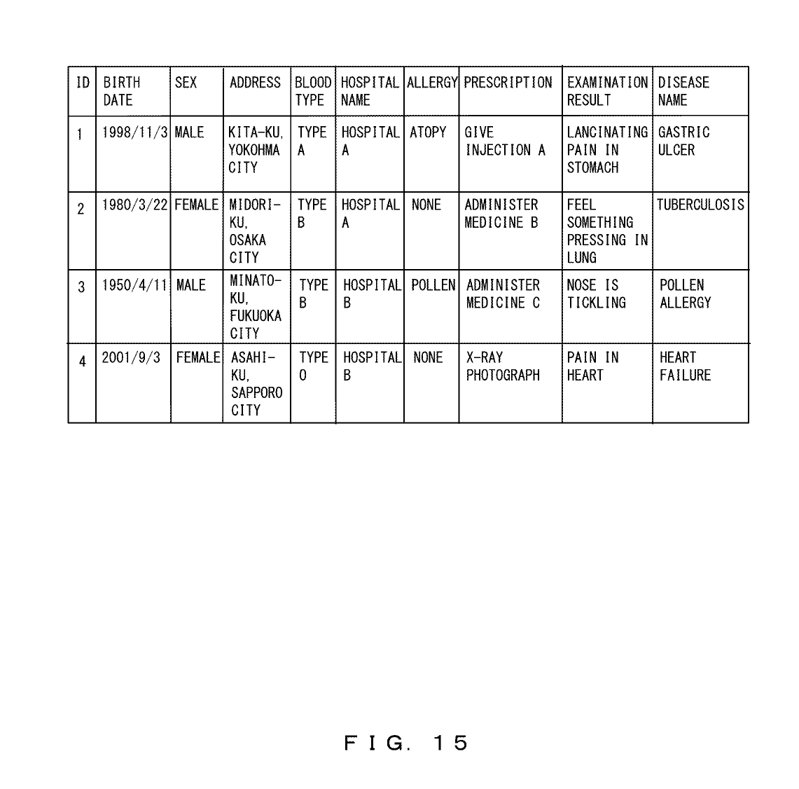

FIG. 15 illustrates an example of the integrated analysis target information 655 that is generated by merging the analysis target information of FIG. 13 and the analysis target information of FIG. 14. The integrated analysis target information 655 of FIG. 15 has similar items as those of the analysis target information of FIG. 13 and FIG. 14. However, IDs in FIG. 15 are IDs assigned by the aggregating device 625, and is different from the IDs of the respective hospitals.

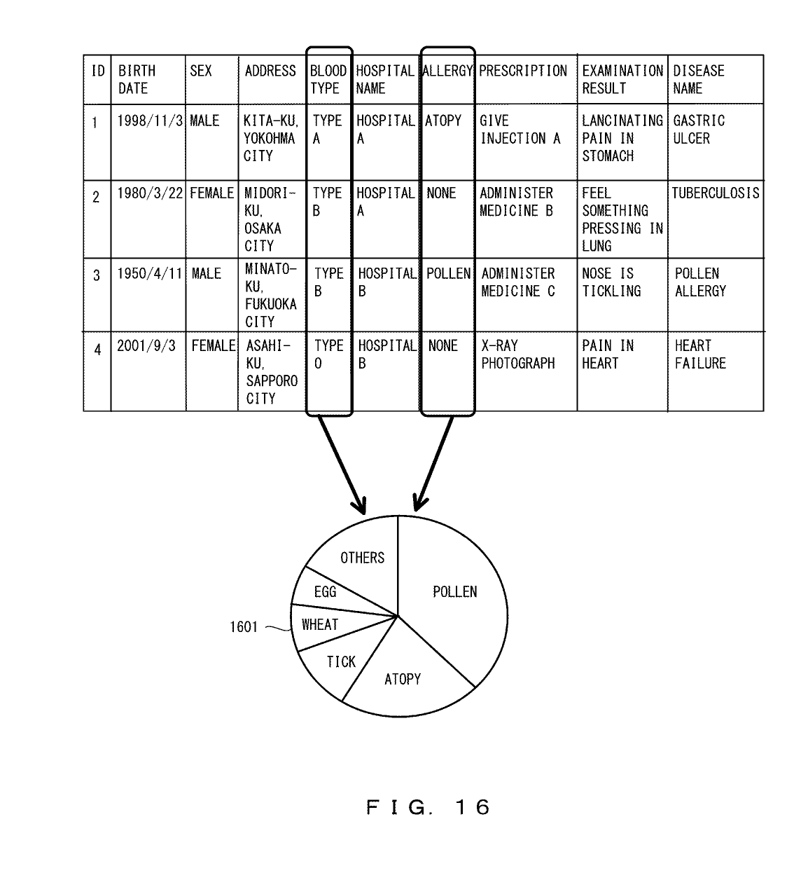

FIG. 16 illustrates an example of an analysis process for the integrated analysis target information 655 of FIG. 15. In the analysis process of FIG. 16, in order to extract an allergy that patients whose blood type is B have, the analysis pattern 656 including the items of blood type and allergy is used. As a result, “none” is extracted as the allergy of the patient who has the ID “2” and whose blood type is B, and “pollen” is extracted as the allergy of the patient who has the ID “3” and whose blood type is B.

When entries of other patients having allergies are included in the integrated analysis target information 655 in addition to the patients having the ID “1” through the ID “4”, a pie graph 1601 representing the ratio of each of the plurality of allergies among all entries for the patients whose blood type is B is generated. Then, the analysis result including the pie graph 1601 is stored in the analysis result DB 657. The pie graph 1601 indicates that there are many allergies of “pollen” and “atopy” among patients whose blood type is B.

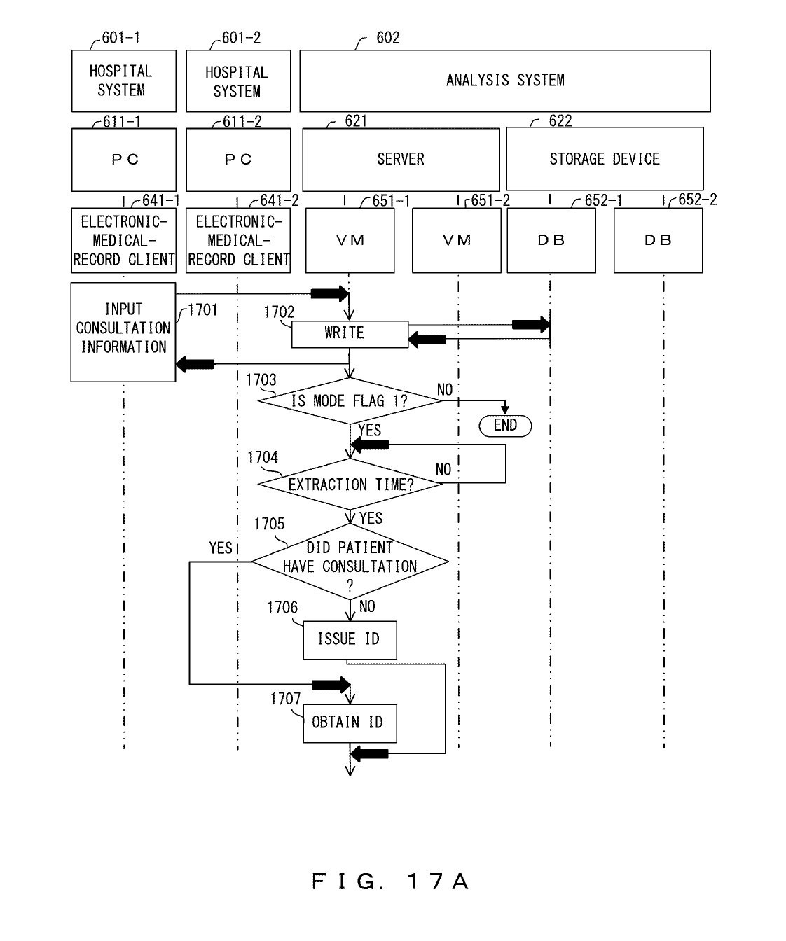

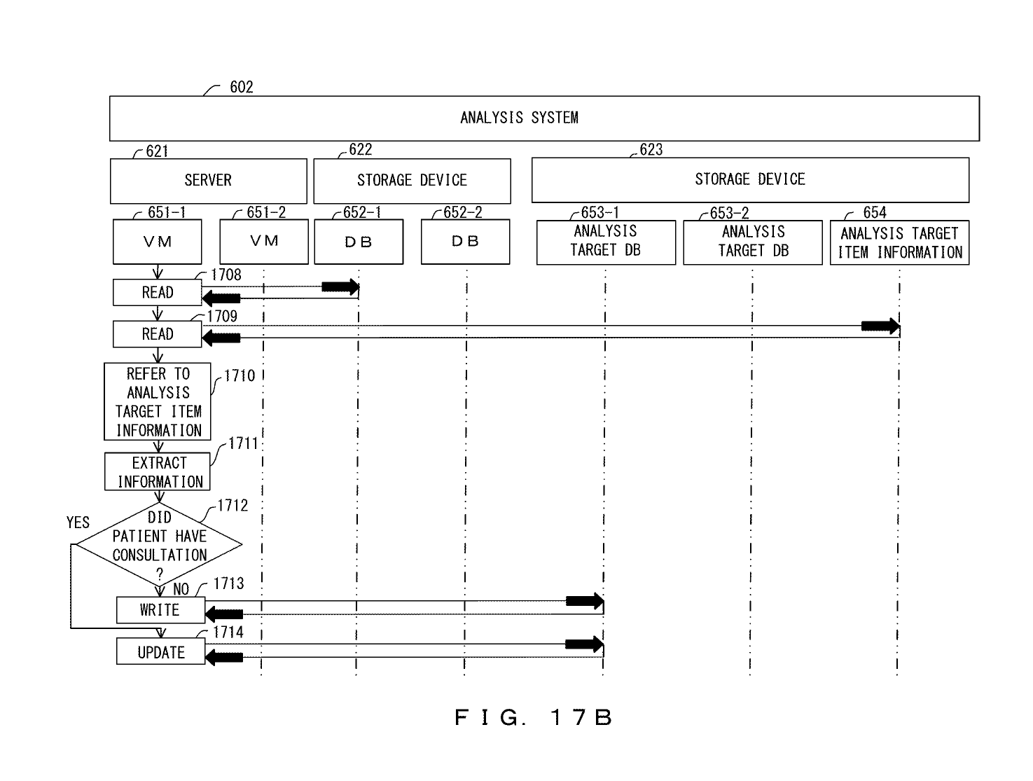

FIG. 17A and FIG. 17B illustrate an example of an information extraction sequence that extracts the analysis target information of hospital A in the analysis system 602. First, the electronic-medical-record client 641-1 inputs the consultation information of a patient to the VM 651-1 in accordance with manipulation conducted by a doctor of hospital A (step 1701). Then, the VM 651-1 writes the input consultation information to the DB 652-1 of the storage device 622 as medical record information (step 1702).

Next, the VM 651-1 checks the mode flag 711-1 (step 1703), and when the mode flag 711-1 is logic “0” (NO in step 1703), the process is terminated. When the mode flag 711-1 is logic “1” (YES in step 1703), the VM 651-1 checks whether or not an extraction time that was scheduled beforehand has arrived (step 1704).

When the extraction time has not arrived (NO in step 1704), the VM 651-1 repeats the process instep 1704. When the extraction time arrives (YES in step 1704), the VM 651-1 refers to the patient list 712-1 so as to check whether or not the patient of the medical record information written to the DB 652-1 had consultation in the past (step 1705). When the name in the medical record information is included in the patient list 712-1, the VM 651-1 determines that the patient had consultation, and when the name in the medical record information is not included in the patient list 712-1, the VM 651-1 determines that the patient did not have consultation.

When determining that the patient did not have consultation (NO in step 1705), the VM 651-1 issues a new ID, and registers the name of the patient and the issued ID in an associated manner in the patient list 712-1 (step 1706). Then, the VM 651-1 assigns the issued ID to the medical record information written to the DB 652-1.

When the patient had consultation (YES in step 1705), the VM 651-1 obtains the ID corresponding to the name of that patient from the list 712-1 (step 1707). Then, the VM 651-1 assigns the obtained ID to the medical record information written to the DB 652-1.

Next, the VM 651-1 reads medical record information written after the last extraction time as difference medical record information (step 1708), and reads the analysis target item information 654 from the storage device 623 (step 1709). Then, the VM 651-1 refers to the analysis target item information 654 (step 1710), and extracts information of an item as an analysis target from the difference medical record information. In doing so, the VM 651-1 may also extract information of an item as a non analysis target temporarily and apply a confidentialization process to the information so as to process the information to information that does not allow the identification of a person such as the addresses in FIG. 13 and FIG. 14.

Next, the VM 651-1 again checks the determination result instep 1705 (step 1712). When the patient did not have consultation (NO in step 1712), the VM 651-1 writes the extracted information to the analysis target DB 653-1 of the storage device 623 as analysis target information of a new patient (step 1713).

When the patient had consultation (YES in step 1712), the VM 651-1 uses the extracted information to update the analysis target information of the same ID as that stored in the analysis target DB 653-1 (step 1714). For example, when the extracted information corresponds to prescription, an examination result or a hospital name, the extracted information is added to the information of the item included in the existing analysis target information. Alternatively, the existing analysis target information is rewritten to the extracted information.

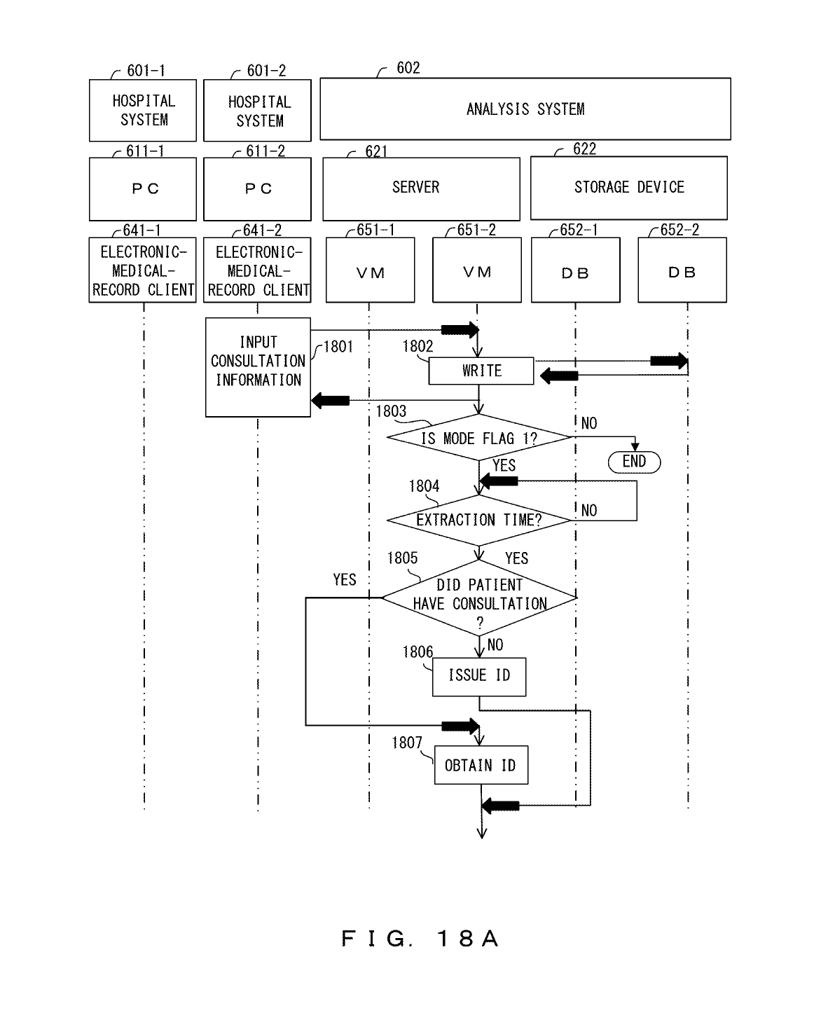

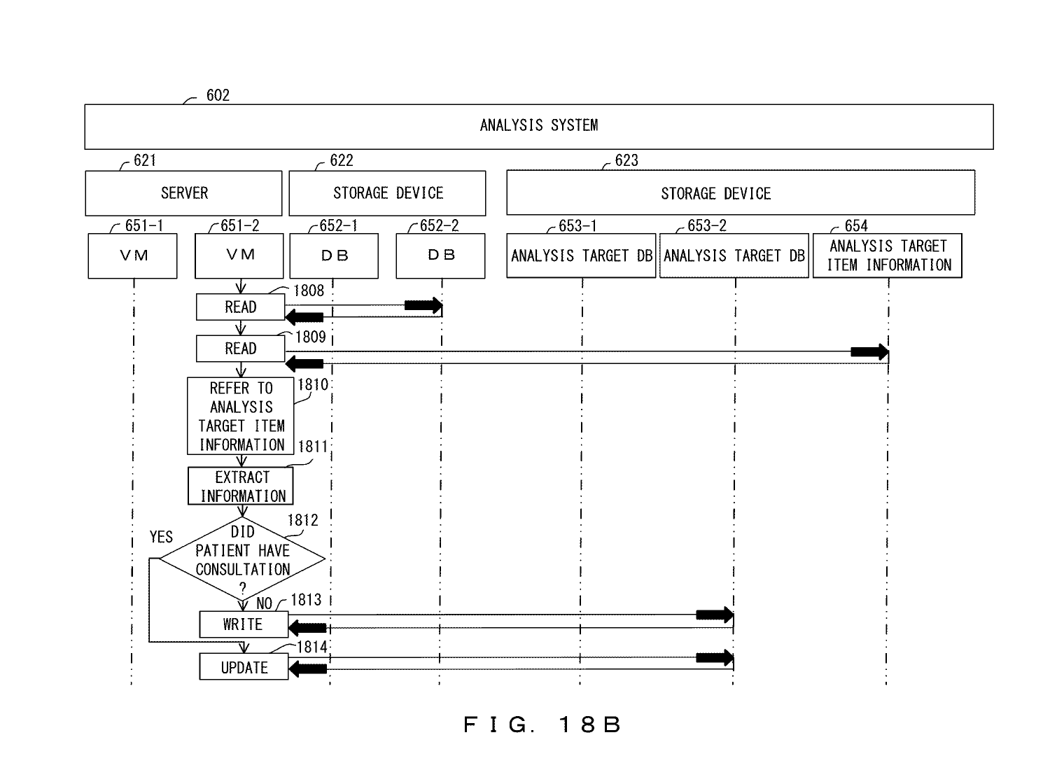

FIG. 18A and FIG. 18B illustrate an example of an information extraction sequence that extracts analysis target information of hospital B in the analysis system 602. The processes in step 1801 through step 1814 are similar to those in step 1701 through 1714.

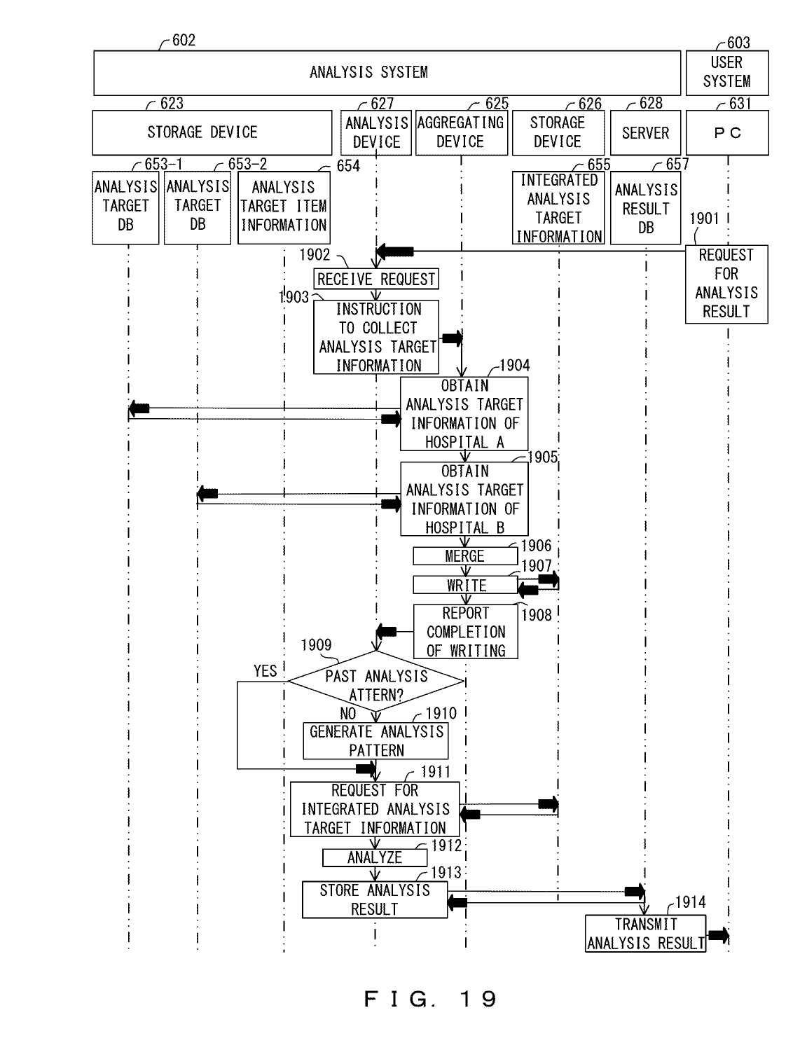

FIG. 19 illustrates an example of a first information analysis sequence in the analysis system 602. First, the PC 631 of the user system 603 makes a request to the analysis device 627 for the analysis result in accordance with manipulation conducted by an user of an information using institution (step 1901). In accordance with manipulation conducted by an analyzer, the analysis device 627 receives the request from the PC 631 (step 1902) and instructs the aggregating device 625 to collect analysis target information (step 1903).

The aggregating device 625 obtains analysis target information of hospital A from the analysis target DB 653-1 of the storage device 623 (step 1904) and obtains analysis target information of hospital B from the analysis target DB 653-2 (step 1905). Next, the aggregating device 625 merges the analysis target information of hospital A and the analysis target information of hospital B so as to generate the integrated analysis target information 655 (step 1906). Then, the aggregating device 625 writes the integrated analysis target information 655 to the storage device 626 (step 1907), and reports the completion of the writing to the analysis device 627 (step 1908).

The analysis device 627 checks whether or not the request from the user corresponds to the analysis pattern 656 of the past. When the request from the user does not correspond to the analysis pattern 656 of the past (NO in step 1909), the analysis device 627 generates new analysis pattern 656 in accordance with manipulation conducted by the analyzer (step 1910). Then, the analysis device 627 makes a request to the storage device 626 for the integrated analysis target information 655 corresponding to the generated analysis pattern 656, and receives the integrated analysis target information 655 from the storage device 626 (step 1911).

When the request from the user corresponds to the analysis pattern 656 of the past (YES in step 1909), the analysis device 627 makes a request to the storage device 626 for the integrated analysis target information 655 corresponding to that analysis pattern 656 (step 1911). Then, the analysis device 627 receives the integrated analysis target information 655 from the storage device 626.

Next, in accordance with manipulation conducted by the analyzer, the analysis device 627 analyzes the received integrated analysis target information 655 (step 1912), and stores the analysis result in the analysis result DB 657 of the server 628 (step 1913). Then, the server 628 transmits the analysis result to the PC 631 of the user system 603 (step 1914).

While the analysis system 602 includes each one of the sever 621, the storage device 622 and the storage device 623, the analysis system 602 may include a plurality of servers and a plurality of storage devices when many hospitals provide medical record information. Thereby, it is possible to perform an information extraction process and an analysis process even when the number of hospitals that provides medical record information increases.

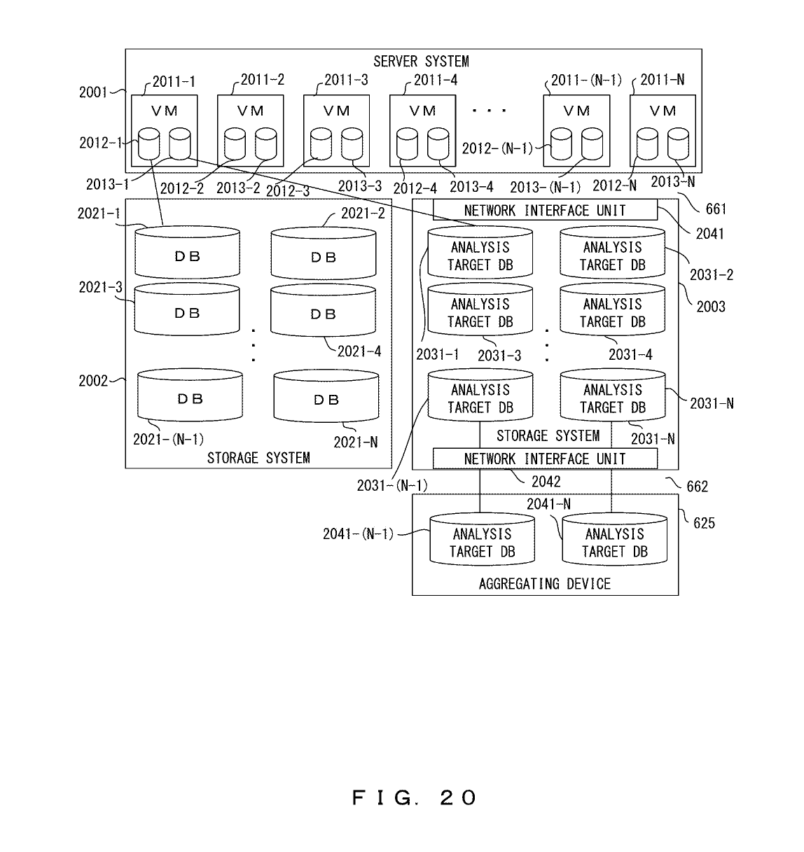

FIG. 20 illustrates configuration examples of a server system and a storage system provided to the analysis system 602. In such a case, the sever 621, the storage device 622 and the storage device 623 illustrated in FIG. 6 are respectively replaced with a server system 2001, a storage system 2002 and a storage system 2003.

In the server system 2001, VMs 2011-1 through 2011-N of N (N is an integer equal to or greater than two) hospitals operate. The server system 2001 includes a plurality of servers (not illustrated), and one or more VMs 2011-i (i=1 through N) operate in each of the servers. The VM 2011-i has a configuration in which the DB 703-i and the analysis target DB 704-i in the VM 651-i of FIG. 7 have been respectively replaced with a DB 2012-i and an analysis target DB 2013-i.

The storage system 2002 includes DBs 2021-1 through 2021-N of N hospitals. The storage system 2002 corresponds to a storage pool including a plurality of storage devices (not illustrated), and each of the storage devices includes one or more DBs 2021-i.

The storage system 2003 includes analysis target DBs 2031-1 through 2031-N of N hospitals. The storage system 2003 corresponds to a storage pool including a plurality of storage devices (not illustrated), and each of the storage devices includes one or more analysis target DBs 2031-i.

The storage system 2003 includes a network interface unit 2041 connected to the communication network 661 and a network interface unit 2042 connected to the communication network 662.

The VM 2011-i of the server system 2001 accesses the storage system 2002 via the communication network 661 and holds the logical volume corresponding to the physical volume of the DB 2021-i as the DB 2012-i. Also, the VM 2011-i accesses the storage system 2003 via the communication network 661 and holds the logical volume corresponding to the physical volume of the analysis target DB 2031-i as the analysis target DB 2013-i.

The aggregating device 625 accesses the storage system 2003 via the communication network 662 and holds the logical volume corresponding to the physical volume of the analysis target DB 2013-i as the analysis target DB 2041-i.

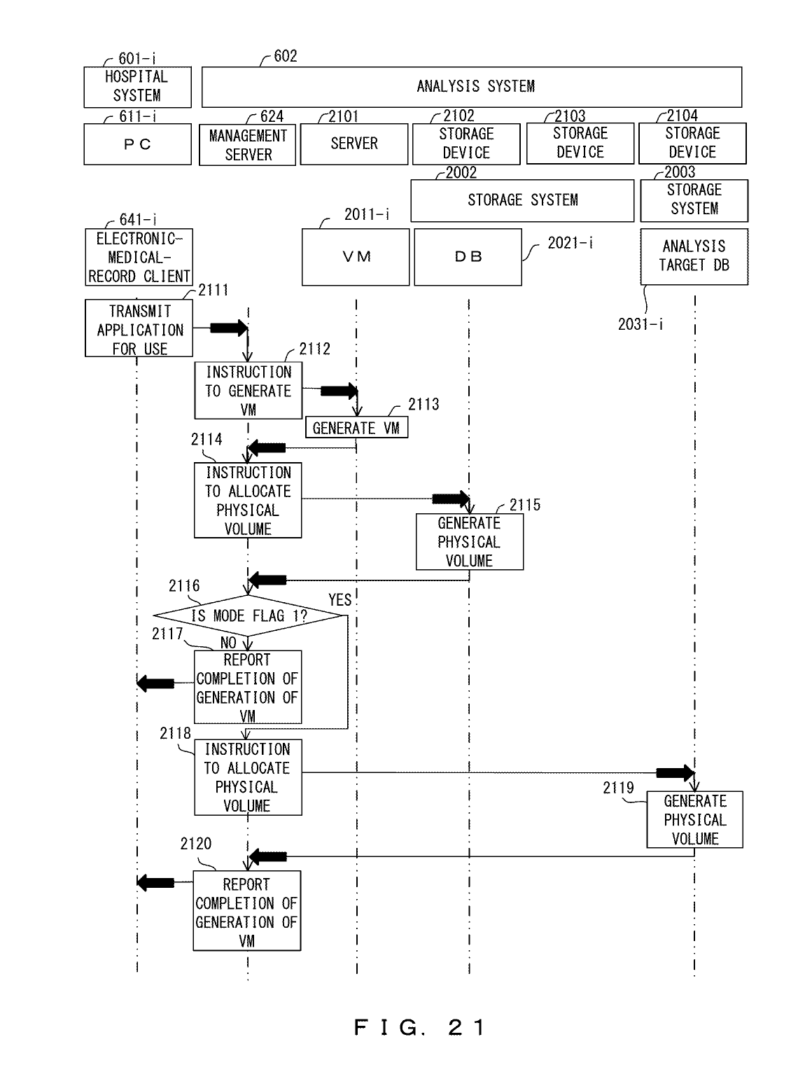

FIG. 21 illustrates an example of a first volume-allocation sequence in which a physical volume is allocated to the VM 2011-i of the i-th hospital (i=1 through N) in the analysis system 602 that has the configuration illustrated in FIG. 20. The hospital system 601-i of the i-th hospital includes the PC 611-i and the electronic-medical-record client 641-i has been installed in the PC 611-i. A server 2101 is included in the server system 2001, a storage device 2102 and storage device 2103 are included in the storage system 2002, and a storage device 2104 is included in the storage system 2003.

First, in accordance with manipulation conducted by a doctor of the i-th hospital, the electronic-medical-record client 641-i transmits an application for the use of an electronic-medical-record service (step 2111). An application for use includes information representing whether or not to permit the provision of medical record information to an information analysis institution.

The management server 624 instructs the server 2101 to generate a VM (step 2112), and the server 2101 generates a VM 2011-i (step 2113). When the application for the user permits the provision of medical record information, the server 2101 sets the mode flag 711-i of the VM 2011-i to logic “1”, and when the application for the user does not permit the provision of medical record information, the server 2101 sets the mode flag 711-i to logic “0”.

Next, the management server 624 instructs the storage device 2102 to allocate a physical volume (step 2114), and the storage device 2102 generates a physical volume of the DB 2021-i (step 2115).

Next, the management server 624 checks the mode flag 711-i of the VM 2011-i (step 2116). When the mode flag 711-i is logic “0” (NO in step 2116), the management server 624 reports the completion of the generation of a VM to the PC 611-i (step 2117).

When the mode flag 711-i is logic “1” (YES in step 2116), the management server 624 instructs the storage device 2104 to allocate a physical volume (step 2118). Then, the storage device 2104 generates a physical volume of the analysis target DB 2031-i (step 2119), and the management server 624 reports the completion of the generation of a VM to the PC 611-i (step 2120).

In the information processing system 600 illustrated in FIG. 6, the information provision institution may be an institution other than a hospital that provides consultation information of a patient. Examples of an information provision institution may include a store that provides purchase information of a customer, an educational institution such as a school, a cram school, etc. that provides grade information of a student or a financial institution such as a bank etc. that provides balance in account, a transaction record, etc. of a customer.

When an information provision institution is a store, purchase information of a customer is collected instead of medical record information, and analysis result representing tastes etc. of the customer is provided to an information using institution such as a restaurant etc. When an information provision institution is an educational institution, grade information of a student is collected and analysis result representing tendency etc. for each subject is provided to an information using institution such as a teaching material production company etc. When in information provision institution is a financial institution, balance in account, a transaction record, etc. of a customer is collected and analysis result representing the use state of a loan etc. is provided to an information using institution such as a loan company etc.

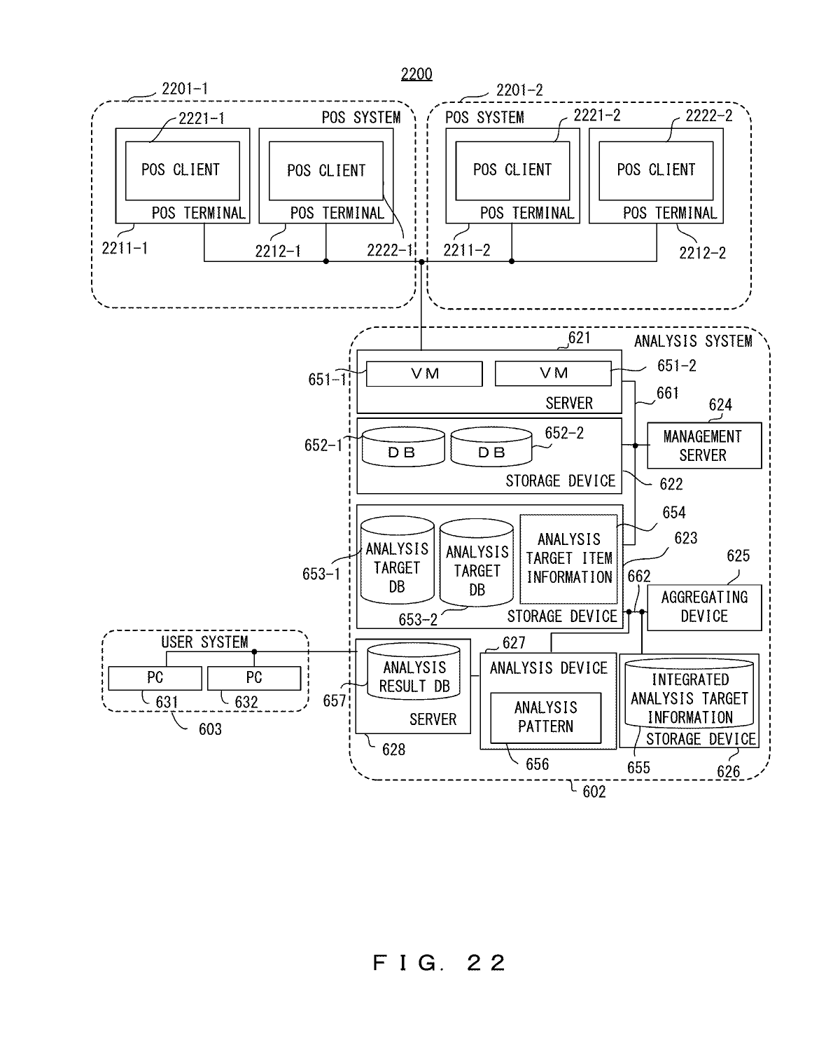

FIG. 22 illustrates a specific example of the information processing system 401 in a case when an information provision institution is a convenience store. An information processing system 2200 illustrated in FIG. 22 has a configuration in which the hospital systems 601-1 and 601-2 have been replaced with a Point Of Sales (POS) system 2201-1 and a POS system 2201-2 in the information processing system 600 illustrated in FIG. 6. The POS system 2201-1 is a system of convenience store A, and the POS system 2201-2 is a system of convenience store B.

The POS system 2201-i (i=1, 2) includes a POS terminal 2211-i and a POS terminal 2212-i. In the POS terminal 2211-i and the POS terminal 2212-i, POS client 2221-i and POS client 2222-i, which are applications, are installed, respectively. The POS system 2201-i may include as many POS terminals as there are stores.

In such a case, the VM 651-i of FIG. 7 executes a POS service instead of the electronic-medical-record service 701-i, and the DB 652-i stores purchase information of a customer instead of medical record information. The user system 603 is for example a system of an information using institution such as a restaurant.

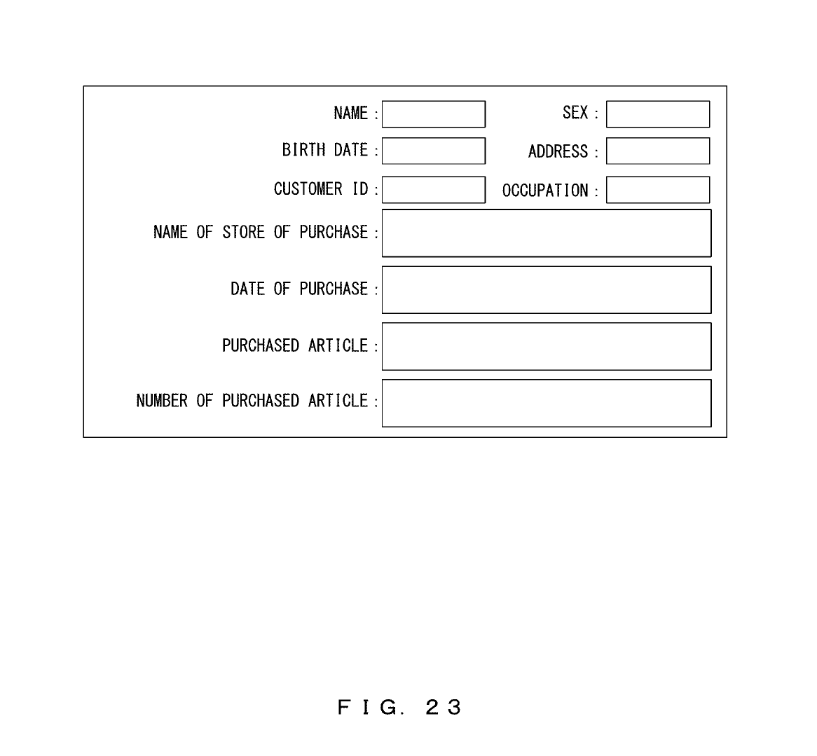

FIG. 23 illustrates an example of an input screen, displayed by the POS terminal 2211-i or the POS terminal 2212-i, of purchase information that uses a common format. The input screen illustrated in FIG. 23 includes items of name of customer, sex, birth date, address, customer ID, occupation, name of store of purchase, date of purchase, purchased article, and the number of purchased articles.

A customer ID is for example an ID that is assigned to a customer by a provider of a point card, and when the customer presents the point card upon purchasing an article at a convenience store, a clerk can input the customer ID. When the registration information of the point card includes name, sex, birth date, address and occupation, such pieces of information are also input upon a purchase of an article.

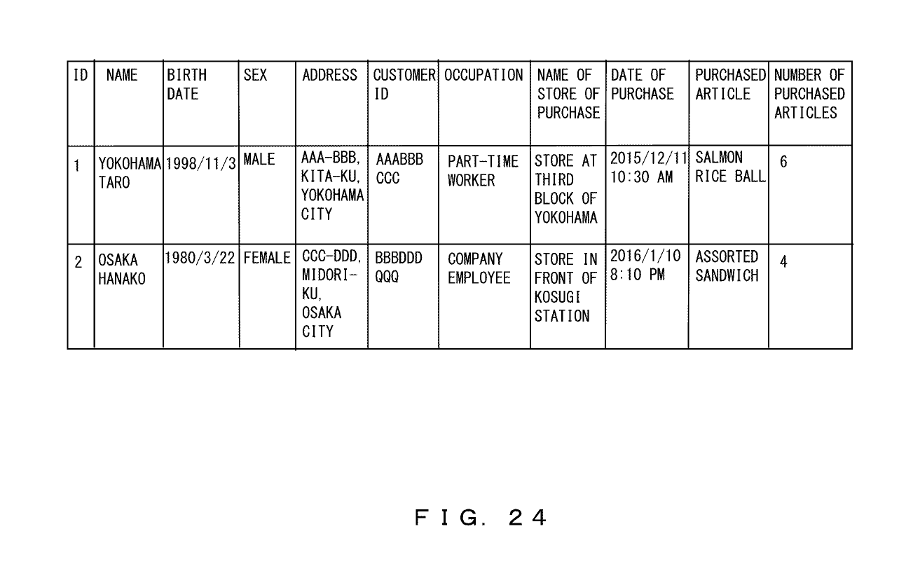

FIG. 24 illustrates an example of purchase information stored in the DB 652-1 of convenience store A. The purchase information illustrated in FIG. 24 includes items of ID, name, birth date, sex, address, customer ID, occupation, name of store of purchase, date of purchase, purchased article and the number of purchased articles. An ID is an ID assigned to a customer by each convenience store, a purchased article is the name of an article that the customer has purchased, and the number of purchased articles is the number of the articles that the customer has purchased. In the example of FIG. 24, purchase information of two customers corresponding to ID “1” and ID “2” are registered in the DB 652-1.

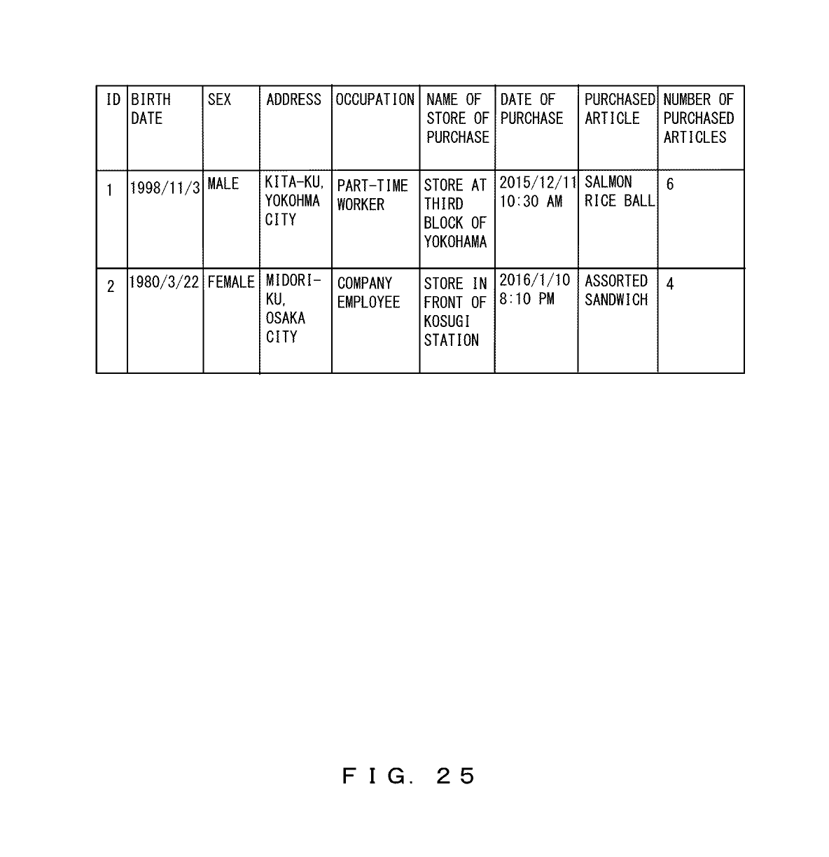

FIG. 25 illustrates an example of analysis target information generated from the purchase information of FIG. 24 on the basis of the analysis target item information 654. The analysis target information of FIG. 25 includes items of ID, birth date, sex, address, occupation, name of store of purchase, date of purchase, purchased article and the number of purchased articles. In such a case, because the names and customer IDs are specified as information to be confidentialized by the analysis target item information 654, they have not been extracted as analysis target information. Similarly to the analysis target information of FIG. 13, the addresses have been processed to information that does not allow the identification of the person.

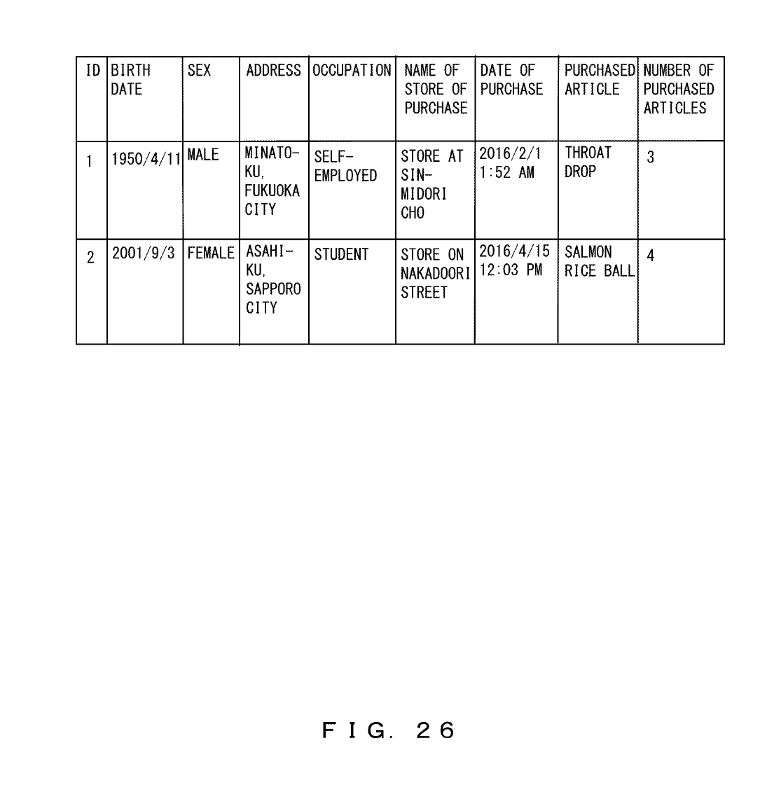

FIG. 26 illustrates an example of analysis target information generated from purchase information of convenience store B on the basis of the analysis target item information 654. The analysis target information of FIG. 26 has similar items to those of the analysis target information of FIG. 25.

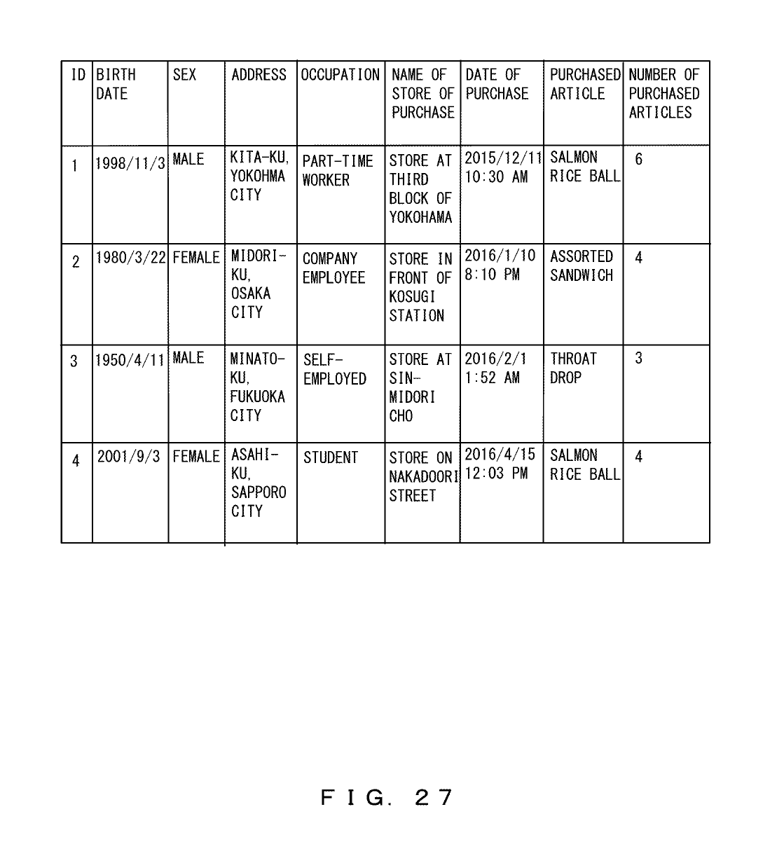

FIG. 27 illustrates an example of the integrated analysis target information 655 generated by merging the analysis target information of FIG. 25 and analysis target information of FIG. 26. The integrated analysis target information of FIG. 27 has similar items to those of the analysis target information of FIG. 25 and FIG. 26.

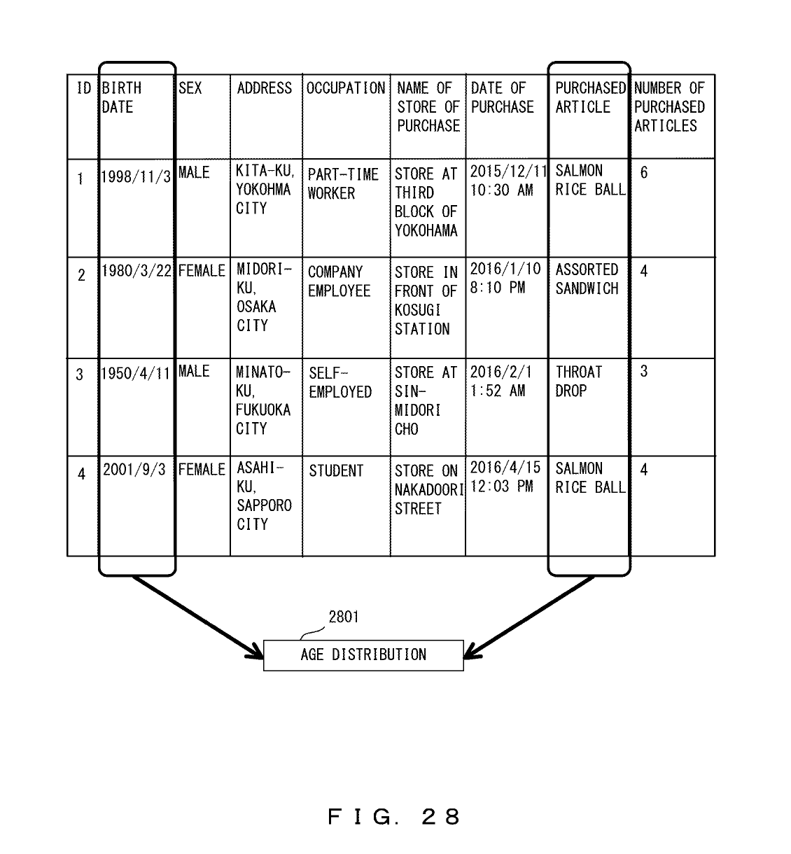

FIG. 28 illustrates an example of an analysis process for the integrated analysis target information 655 of FIG. 27. In the analysis process illustrated in FIG. 28, the analysis pattern 656 including the items of birth date and the purchased article is used in order to extract the age group of customers who purchased “salmon rice ball”. As a result, “Nov. 13, 1998” is extracted as the birth date of the customer with ID “1” who purchased “salmon rice ball”, and “Sep. 3, 2001” is extracted as the birth date of the customer with ID “4” who purchased the same article.

When an entry of a customer who purchased “salmon rice ball” is included in the integrated analysis target information 655 in addition to the customers with IDs “1” and “4”, age distribution 2801 is generated from the birth dates of such customers. Then, the analysis result including the age distribution 2801 is stored in the analysis result DB 657. The age distribution 2801 indicates that young people has a tendency to like “salmon rice ball”.

Incidentally, in the analysis system 602 illustrated in FIG. 20, the aggregating device 625 collects pieces of analysis target information from N hospitals from the analysis target DBs 2031-1 through 2031-N of the storage system 2003. Thus, an increase in the number of hospitals also increases the data amount of analysis target information, leading to longer collection time for collecting analysis target information.

For example, even when an analyzer wishes to use only the analysis target information of a specific hospital, the analysis system 602 illustrated in FIG. 20 collects the analysis target information of all the hospitals, and thus the collection time is not different from collection time in a case where analysis target information of all the hospitals is analyzed. Accordingly, it is desirable that an arrangement that allows the aggregating device 625 to obtain only analysis target information of a specific hospital be provided.

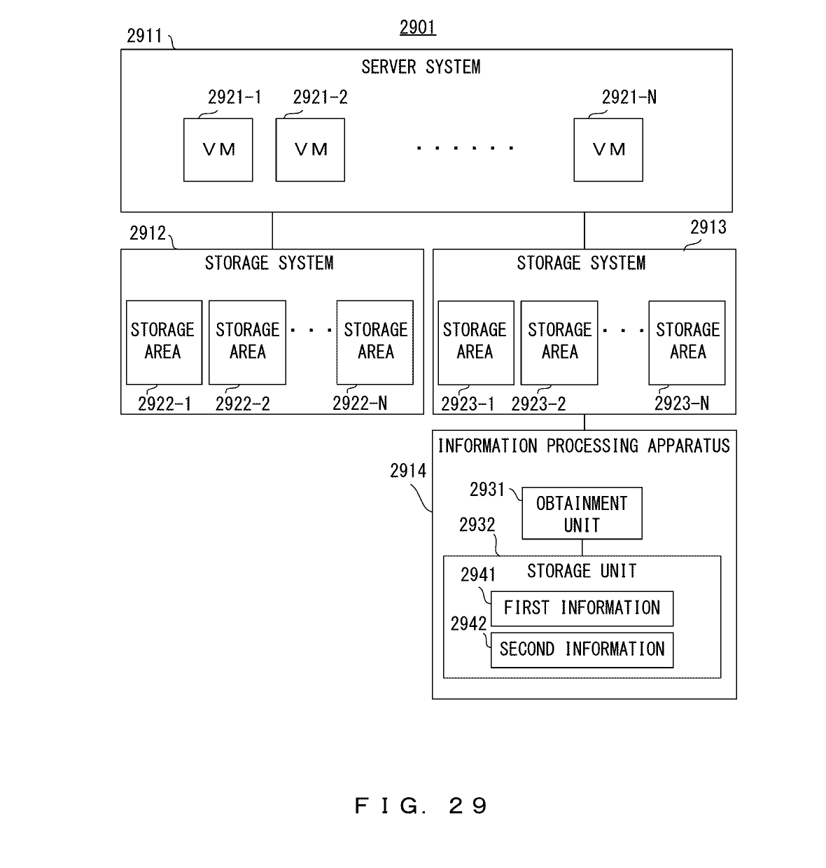

FIG. 29 illustrates a configuration example of a second information processing system in which such an arrangement is provided. An information processing system 2901 of FIG. 29 includes a server system 2911, a storage system 2912, a storage system 2913 and an information processing apparatus 2914.

The server system 2911 includes VMs 2921-1 through 2921-N of N information provision institutions. The storage system 2912 includes storage areas 2922-1 through 2922-N, the storage system 2913 includes storage areas 2923-1 through 2923-N, and the information processing apparatus 2914 includes an obtainment unit 2931 and a storage unit 2932.

The storage system 2912 includes a plurality of storage devices (not illustrated), and the storage area 2922-i (i=1 through N) is included in any of the storage devices. The storage system 2913 includes a plurality of storage devices (not illustrated) and the storage area 2923-i is included in any of the storage devices.

The storage system 2912 stores information transferred from the i-th information provision institution in the storage area 2922-i. The VM 2921-i extracts analysis target information from the information stored in the storage area 2922-i and stores the extracted analysis target information in the storage area 2923-i.

The storage unit 2932 of the information processing apparatus 2914 stores first information 2941 and second information 2942. The first information 2941 represents a correspondence relationship between the VMs 2921-1 through 2921-N and the storage areas 2923-1 through 2923-N, and the second information 2942 represents a correspondence relationship between the N information provision institutions and the VMs 2921-1 through 2921-N.

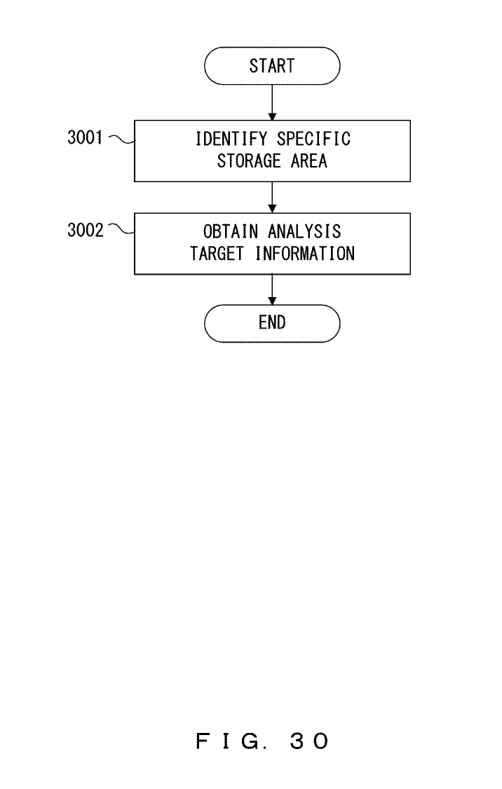

FIG. 30 is a flowchart illustrating an example of an information obtainment process performed by the information processing apparatus 2914 of FIG. 29. First, on the basis of the first information 2941 and the second information 2942, the obtainment unit 2931 identifies a specific storage area that stores analysis target information of a specific information provision institution from among the storage areas 2923-1 through 2923-N. Then, the obtainment unit 2931 obtains analysis target information of the specific information provision institution from a storage device including the identified storage area (step 3002).

The information processing system 2901 as described above makes it possible to reduce the risk of information leak and to reduce time for collecting pieces of analysis target information of a specific information provision institution, in a case when pieces of information collected from a plurality of information provision institutions are analyzed. The information processing system 600 illustrated in FIG. 6 corresponds to the specific example of the information processing system 2901 of FIG. 29.

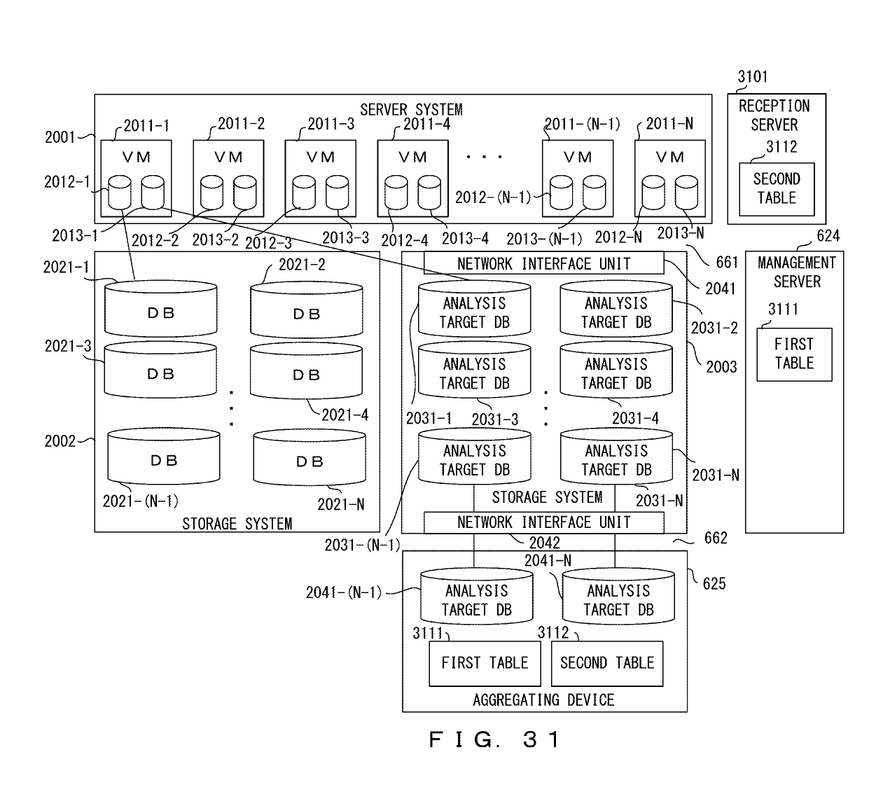

FIG. 31 illustrates a configuration example of the analysis system 602 included in the specific example of the information processing system 2901 of FIG. 29. The analysis system 602 illustrated in FIG. 31 employs a configuration in which a reception server 3101 is added to the analysis system 602 of FIG. 6. However, the sever 621, the storage device 622 and the storage device 623 of FIG. 6 have been replaced with the server system 2001, the storage system 2002 and the storage system 2003 of FIG. 20, respectively.

The server system 2001 corresponds to the server system 2911 of FIG. 29, and the VM 2011-i corresponds to the VM 2921-i. The server system 2002 corresponds to the storage system 2912, and the physical volume of the DB 2021-i corresponds to the storage area 2922-i. The storage system 2003 corresponds to the storage system 2913, and the physical volume of the analysis target DB 2031-i corresponds to the storage area 2923-i. The aggregating device 625 corresponds to the information processing apparatus 2914.

The management server 624 stores the first table 3111, and the reception server 3101 stores the second table 3112. The first table 3111 corresponds to the first information 2941, and represents a correspondence relationship between the VMs 2011-1 through 2011-N and the physical volumes of the analysis target DBs 2031-1 through 2031-N. The second table 3112 corresponds to the second information 2942, and represents a correspondence relationship between N hospitals and the VMs 2011-1 through 2011-N.

The aggregating device 625 obtains the first table 3111 from the management server 624, and obtains the second table 3112 from the reception server 3101. On the basis of the first table 3111 and the second table 3112, the aggregating device 625 identifies the physical volume of the analysis target DB 2031-i of the specific hospital. Then, the aggregating device 625 obtains analysis target information of that hospital from the storage device including the physical volume of the identified analysis target DB 2031-i.

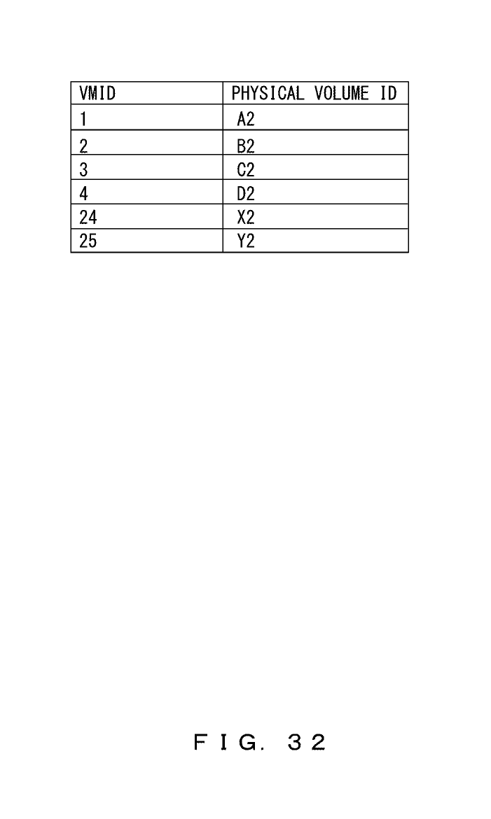

FIG. 32 illustrates an example of the first table 3111. The first table 3111 of FIG. 32 includes items of VMID and physical volume ID. A VMID is the ID of the VM 2011-i, and a physical volume ID is the ID of the physical volume of the analysis target DB 2031-i. The first table 3111 stores each physical volume ID and its corresponding VMID in an associated manner. In this example, VMID “1” is the ID of the VM 2011-1 of hospital A, and physical volume ID “A2” is the ID of the physical volume of the analysis target DB 2031-1 of hospital A.

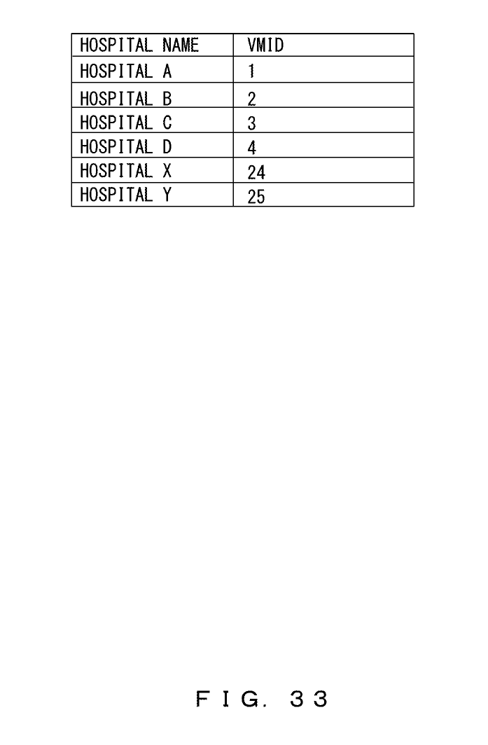

FIG. 33 illustrates an example of the second table 3112. The second table 3112 of FIG. 33 includes items of hospital name and VMID. The second table 3112 stores each VMID and the hospital name of its corresponding hospital in an associated manner.

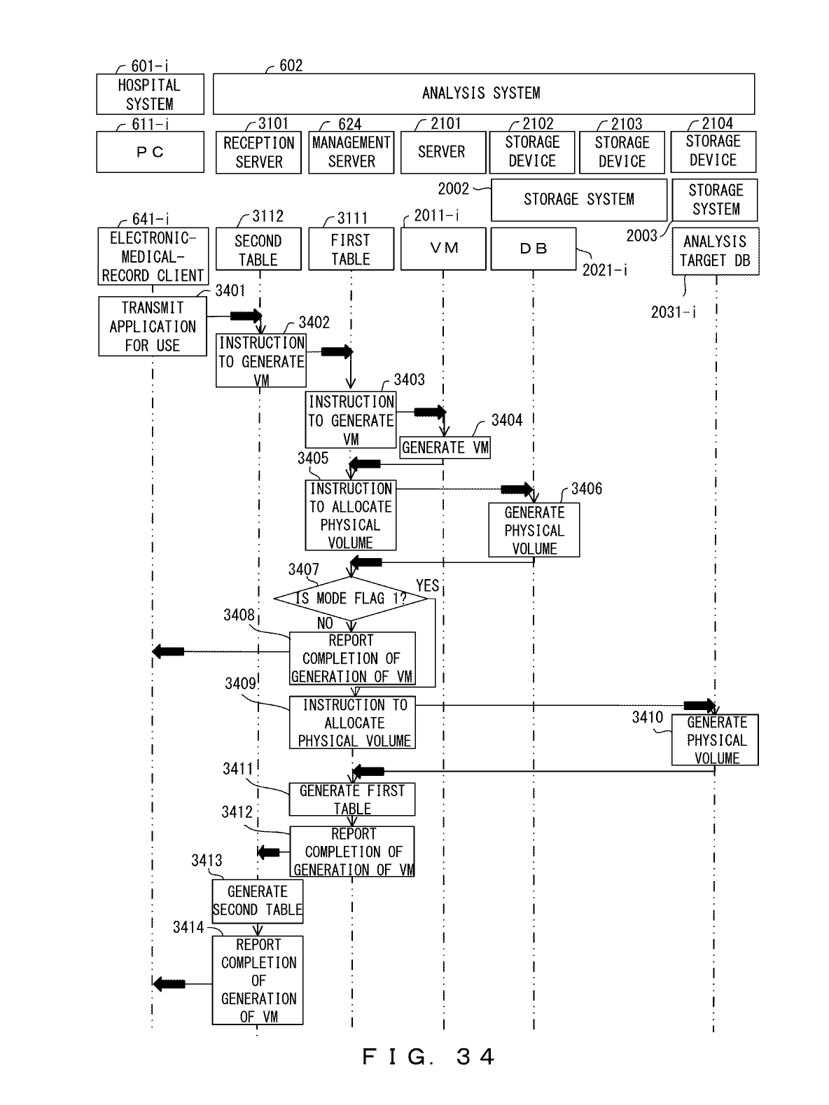

FIG. 34 illustrates an example of a second volume-allocation sequence in which a physical volume is allocated to the VM 2011-i of the i-th hospital in the analysis system 602 that has the configuration illustrated in FIG. 31.

First, the electronic-medical-record client 641-i transmits an application for use of an electronic-medical-record service to the reception server 3101 of the analysis system 602 in accordance with manipulation conducted by a doctor of the i-th hospital (step 3401). Then, the reception server 3101 instructs the management server 624 to generate a VM (step 3402). The processes in the subsequent steps 3403 through 3410 are similar to the processes in steps 2112 through 2119 of FIG. 21.

Thereafter, the management server 624 generates an entry, for the first table 3111, that associates the ID of the VM 2011-i generated in step 3404 and the ID of the physical volume of the analysis target DB 2031-i generated in step 3410 (step 3411). Then, the management server 624 reports the completion of the generation of the VM to the reception server 3101 (step 3412).

Next, the reception server 3101 generates an entry, for the second table 3112, that associates the hospital name of the i-th hospital, which transmitted the application for use in step 3401, and the ID of the VM 2011-i generated in step 3404 (step 3413). Then, the reception server 3101 reports the completion of the generation of the VM to the PC 611-i (step 3414).

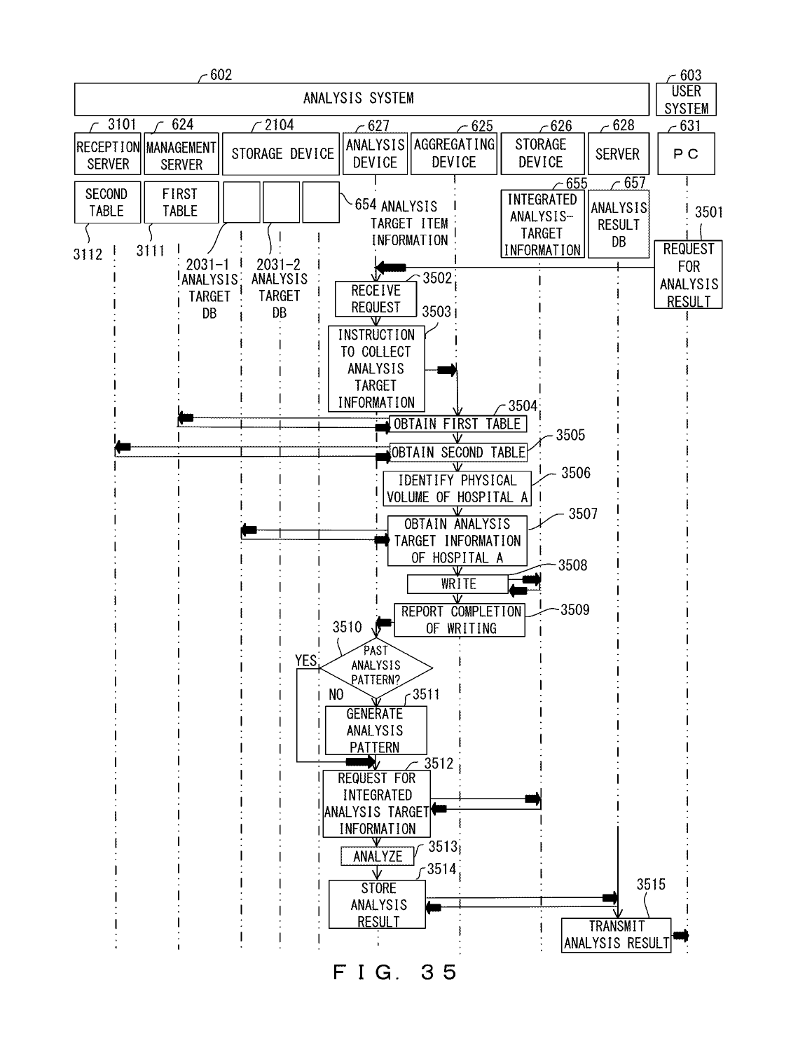

FIG. 35 illustrates an example of a second information analysis sequence that analyzes only analysis target information of hospital A in the analysis system 602 employing the configuration illustrated in FIG. 31. First, in accordance with manipulation conducted by a user of an information using institution, the PC 631 of the user system 603 makes a request to the analysis device 627 for the analysis result (step 3501). The analysis device 627, in accordance with manipulation conducted by an analyzer, receives the request from the PC 631 (step 3502), and instructs the aggregating device 625 to collect pieces of analysis target information of hospital A (step 3503).

The aggregating device 625 obtains the first table 3111 from the management server 624 (step 3504), and obtains the second table 3112 from the reception server 3101 (step 3505). Then, the aggregating device 625 uses the first table 3111 and the second table 3112 so as to identify the physical volume of the analysis target DB 2031-1 of hospital A (step 3506). In doing so, the aggregating device 625 obtains VMID “1” corresponding to hospital A from the second table 3112 of FIG. 33 and obtains physical volume ID “A2” corresponding to VMID “1” from the first table 3111 of FIG. 32.

Next, the aggregating device 625 obtains analysis target information of hospital A from the storage device 2104 including the physical volume of the analysis target DB 2031-1, which is represented by physical volume ID “A2” (step 3507). Then, the aggregating device 625 writes analysis target information of hospital A to the storage device 626 as the integrated analysis target information 655 (step 3508) and reports the completion of the writing to the analysis device 627 (step 3509).

The processes in the subsequent steps 3510 through 3515 are similar to the processes in steps 1909 through 1914 of FIG. 19.

An information analysis sequence as described above makes it possible to collect pieces of analysis target information of a specific hospital alone, eliminating the necessity of collecting pieces of analysis target information of other hospitals that are not used for the analysis, and thus makes it possible to reduce the collection time.

It is also possible to collect pieces of analysis target information of a plurality of specific hospitals alone instead of collecting pieces of analysis target information of a single hospital alone. In this case too, it is not necessary to collect pieces of analysis target information of hospitals other than the plurality of specific hospitals, making it possible to reduce the collection time. In the configuration illustrated in FIG. 31, the information provision institution may be a store, an educational institution, a financial institution, etc.

The information processing system 401 illustrated in FIG. 4, the information processing system 600 illustrated in FIG. 6, the information processing system 2200 illustrated in FIG. 22 and the information processing system 2901 illustrated in FIG. 29 are just exemplary, and some of the constituents may be omitted or changed in accordance with the purposes or conditions of the information processing systems. For example, when the analysis device 627 generates the integrated analysis target information 655 in the information processing system 600 illustrated in FIG. 6 and the information processing system 2200 illustrated in FIG. 22, the aggregating device 625 and the storage device 626 may be omitted.

The configuration of the VM 651-i illustrated in FIG. 7 is just exemplary, and some of the constituents may be omitted or changed in accordance with the purposes or conditions of the information processing systems.

The configurations of the storage device 622 and the storage device 623 illustrated in FIG. 8 are just exemplary, and some of the constituents may be omitted or changed in accordance with the configurations or conditions of the information processing systems.

The configurations of the server system 2001, the storage system 2002 and the storage system 2003 illustrated in FIG. 20 and FIG. 31 are just exemplary, and some of the constituents may be omitted or changed in accordance with the configurations or conditions of the information processing systems.

The flowcharts illustrated in FIG. 5 and FIG. 30 and the operation sequences illustrated in FIG. 17A through FIG. 19, FIG. 21, FIG. 34 and FIG. 35 are just exemplary, and some of the processes may be omitted or changed in accordance with the configurations or conditions of the information processing systems. For example, in the information analysis sequences illustrated in FIG. 19 and FIG. 35, the analysis device 627 may start an analysis process in response to a different event as a trigger instead of a request from an information using institution. The analysis device 627 in place of the aggregating device 625 may perform the processes in step 1904 through step 1906 of FIG. 19.

The input screens illustrated in FIG. 9 and FIG. 23, the medical record information illustrated in FIG. 10 and FIG. 11, the purchase information illustrated in FIG. 24, the analysis target item information illustrated in FIG. 12, the analysis target information illustrated in FIG. 13, FIG. 14, FIG. 25 and FIG. 26 and the integrated analysis target information illustrated in FIG. 15 and FIG. 27 are just exemplary. The first table 3111 illustrated in FIG. 32 and the second table 3112 illustrated in FIG. 33 are also just exemplary. These pieces of information may vary in accordance with the purposes or conditions of the information processing systems. The analysis processes illustrated in FIG. 16 and FIG. 28 are just exemplary, and the pattern of an analysis process may vary in accordance with a request from an information using institution.

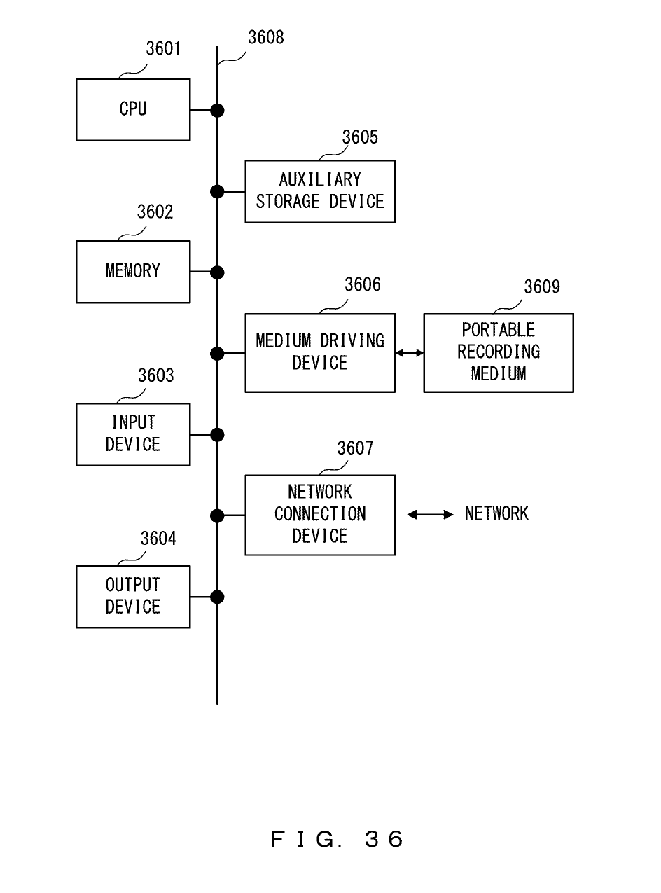

FIG. 36 illustrates a hardware configuration example of an information processing apparatus that is used as the information processing apparatus 413 illustrated in FIG. 4, the sever 621, the management server 624, the aggregating device 625 and the analysis device 627 illustrated in FIG. 6 and FIG. 22 and the information processing apparatus 2914 illustrated in FIG. 29. The information processing apparatus illustrated in FIG. 36 includes a Central Processing Unit (CPU) 3601, a memory 3602, an input device 3603, an output device 3604, an auxiliary storage device 3605, a medium driving device 3606 and a network connection device 3607. These constituents are connected to each other via a bus 3608.

The memory 3602 is for example a semiconductor memory such as a Read Only Memory (ROM), a Random Access Memory (RAM), a flash memory, etc., and stores a program and data used for processes. The memory 3602 can be used as the storage unit 421 illustrated in FIG. 4 when the information processing apparatus illustrated in FIG. 36 is the information processing apparatus 413. The memory 3602 can be used as the storage unit 2932 illustrated in FIG. 29 when the information processing apparatus illustrated in FIG. 36 is the information processing apparatus 2914.

When the information processing apparatus illustrated in FIG. 36 is the information processing apparatus 413, the CPU 3601 (processor) executes a program by using for example the memory 3602 so as to operate as the extraction unit 422 illustrated in FIG. 4. In such a case, the electronic-medical-record service 701-i illustrated in FIG. 7 corresponds to a program executed by the CPU 3601.

When the information processing apparatus illustrated in FIG. 36 is the information processing apparatus 2914, the CPU 3601 executes a program by using for example the memory 3602 so as to operate as the obtainment unit 2931 illustrated in FIG. 29.

The input device 3603 is for example a keyboard, a pointing device, etc., and is used for inputting instructions or information from an operator or a user. The output device 3604 is for example a display device, a printer, a speaker, etc., and is used for outputting inquiries to the operator or the user or for outputting process results. When the information processing apparatus illustrated in FIG. 36 is the analysis device 627, the process result may be an analysis result.

The auxiliary storage device 3605 is for example a magnetic disk device, an optical disk device, a magneto-optical disk device, a tape device, etc. The auxiliary storage device 3605 may be a hard disk drive. The information processing apparatus can store a program and data in the auxiliary storage device 3605 beforehand so as to load them onto the memory 3602 and use them. When the information processing apparatus illustrated in FIG. 36 is the information processing apparatus 413, the auxiliary storage device 3605 may be used as the storage unit 421 illustrated in FIG. 4. When the information processing apparatus illustrated in FIG. 36 is the information processing apparatus 2914, the auxiliary storage device 3605 may be used as the storage unit 2932 illustrated in FIG. 29.

The medium driving device 3606 drives a portable recording medium 3609 so as to access information recorded in it. The portable recording medium 3609 is a memory device, a flexible disk, an optical disk, a magneto-optical disk, etc. The portable recording medium 3609 may be a DVD, a Compact Disk Read Only Memory (CD-ROM), a Universal Serial Bus (USB) memory, etc. The operator or the user can store a program and data in the portable recording medium 3609 so as to load them onto the memory 3602 and use them.

As described above, a computer-readable recording medium that stores a program and data used for processes is a physical (non-transitory) recording medium such as the memory 3602, the auxiliary storage device 3605 or the portable recording medium 3609.

The network connection device 3607 is a communication interface circuit that is connected to a communication network such as a LAN, a Wide Area Network (WAN), etc. so as to perform data conversion accompanying communications. When the information processing apparatus illustrated in FIG. 36 is the information processing apparatus 413, the network connection device 3607 may be used as the transfer unit 423 illustrated in FIG. 4. The information processing apparatus can receive a program and data from an external device via the network connection device 3607 and load them onto the memory 3602 and use them.

Note that it is not necessary for the information processing apparatuses to include all the constituents illustrated in FIG. 36, and some of the constituents can be omitted in accordance with the purposes or conditions. For example, when it is not necessary to input instructions or information from the operator or the user, the input device 3603 can be omitted, and when it is not necessary to output inquiries to the operator or the user or to output process results, the output device 3604 can be omitted. When the portable recording medium 3609 is not used, the medium driving device 3606 can be omitted.

A similar information processing apparatus to that illustrated in FIG. 36 can be used as the PC 611-i and the PC 612-i illustrated in FIG. 6, the PC 2211-i and the PC 2212-i illustrated in FIG. 22, the PC 631 and the PC 632 illustrated in FIG. 6 and FIG. 22 and the reception server 3101 illustrated in FIG. 31.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory that stores a plurality of pieces of information transferred respectively from a plurality of information provision institutions;
a processor that is coupled to the memory and that extracts a plurality of pieces of analysis target information that are to be provided to an analysis device, respectively from the plurality of pieces of information; and
an communication interface circuit that transfers the plurality of pieces of information to a first storage device via a first communication network and transfers the plurality of pieces of analysis target information to a second storage device connected to a second communication network, wherein
the second communication network is separated from the first communication network and the analysis device is connected to the second communication network.

2. The information processing apparatus according to claim 1, wherein
the processor extracts information of an item as an analysis target from each of the plurality of pieces of information on the basis of analysis target item information that specifies the item as the analysis target from among a plurality of items included in each of the plurality of pieces of information and generates the plurality of pieces of analysis target information.

3. The information processing apparatus according to claim 2, wherein
the processor confidentializes information of an item other than the item as the analysis target from among the plurality of items and generates the plurality of pieces of analysis target information including confidentialized information.

4. An information processing system comprising:
a first storage device that is connected to a first communication network and that stores a plurality of pieces of information transferred respectively from a plurality of information provision institutions;
a second storage device that is connected to a second communication network and that stores a plurality of pieces of analysis target information that are to be provided to an analysis device; and
an information processing apparatus that receives the plurality of pieces of information respectively from the plurality of information provision institutions, transfers the plurality of pieces of information to the first storage device via the first communication network, extracts the plurality of pieces of analysis target information respectively from the plurality of pieces of information, and transfers the plurality of pieces of analysis target information to the second storage device, wherein
the second communication network is separated from the first communication network and the analysis device is connected to the second communication network.

5. The information processing system according to claim 4, wherein
the second storage device includes a first network interface circuit that receives the plurality of pieces of analysis target information from the information processing apparatus via the first communication network and a second network interface circuit that is connected to the second communication network.

6. The information processing system according to claim 4, further comprising
an aggregating device that receives the plurality of pieces of analysis target information from the second storage device via the second communication network and that generates integrated analysis target information by merging the received plurality of pieces of analysis target information, and
a third storage device that is connected to the second communication network and that stores the integrated analysis target information, wherein
the analysis device receives the integrated analysis target information from the third storage device via the second communication network, analyzes the received integrated analysis target information, and generates an analysis result.

7. A non-transitory computer-readable recording medium having stored therein a program that causes a computer to execute a process comprising:
transferring a plurality of pieces of information transferred respectively from a plurality of information provision institutions, to a first storage device via a first communication network;
extracting a plurality of pieces of analysis target information respectively from the plurality of pieces of information, the plurality of pieces of analysis target information being to be provided to an analysis device connected to a second communication network that is separated from the first communication network; and
transferring the plurality of pieces of analysis target information to a second storage device that is connected the second communication network.

8. The program according to claim 7, wherein
the extracting of the plurality of pieces of analysis target information extracts information of an item as an analysis target from each of the plurality of pieces of information on the basis of analysis target item information that specifies the item as the analysis target from among a plurality of items included in each of the plurality of pieces of information and generates the plurality of pieces of analysis target information.

9. The program according to claim 8, wherein
the extracting of the plurality of pieces of analysis target information confidentializes information of an item other than the item as the analysis target from among the plurality of items and generates the plurality of pieces of analysis target information including confidentialized information.

10. An information processing apparatus comprising:
a memory that stores first information representing a correspondence relationship between a plurality of virtual machines and a plurality of storage areas and second information representing a correspondence relationship between a plurality of information provision institutions and the plurality of virtual machines, wherein the plurality of virtual machines respectively extract a plurality of pieces of analysis target information from a plurality of pieces of information transferred from a plurality of information provision institutions and respectively store the extracted plurality of pieces of analysis target information in the plurality of storage areas; and
a processor that is coupled to the memory and that identifies a specific storage area that stores analysis target information of a specific information provision institution from among the plurality of storage areas on the basis of the first information and the second information and obtains analysis target information of the specific information provision institution from a storage device that includes the specific storage area.

11. A non-transitory computer-readable recording medium having stored therein a program that causes a computer to execute a process comprising:
identifying a specific storage area that stores analysis target information of a specific information provision institution from among a plurality of storage areas on the basis of first information representing a correspondence relationship between a plurality of virtual machines and the plurality of storage areas and second information representing a correspondence relationship between the plurality of information provision institutions and the plurality of virtual machines, wherein the plurality of virtual machines respectively extract a plurality of pieces of analysis target information from a plurality of pieces of information transferred from a plurality of information provision institutions and respectively store the extracted plurality of pieces of analysis target information in the plurality of storage areas; and
obtaining analysis target information of the specific information provision institution from a storage device that includes the specific storage area.

12. An information processing method comprising:
identifying, by a processor, a specific storage area that stores analysis target information of a specific information provision institution from among a plurality of storage areas on the basis of first information representing a correspondence relationship between a plurality of virtual machines and the plurality of storage areas and second information representing a correspondence relationship between the plurality of information provision institutions and the plurality of virtual machines, wherein the plurality of virtual machines respectively extract a plurality of pieces of analysis target information from a plurality of pieces of information transferred from a plurality of information provision institutions and respectively store the extracted plurality of pieces of analysis target information in the plurality of storage areas; and
obtaining, by the processor, analysis target information of the specific information provision institution from a storage device that includes the specific storage area.
